(19) United States
(12) Patent Application Publication
(10) Pub. No.: US 2017/0078737 A1
(43) Pub. Date: Mar. 16, 2017

(54) DIGITAL DEVICE AND CONTROL METHOD THEREFOR

(71) Applicant: LG ELECTRONICS INC., Seoul (KR)

(72) Inventors: Robert JAGT, Santa Clara, CA (US); Suresh ARUMUGAM, Santa Clara, CA (US); Anupam KAUL, Santa Clara, CA (US); Steve WINSTON, Santa Clara, CA (US); Sallesh RACHABATHUNI, Santa Clara, CA (US)

(73) Assignee: LG ELECTRONICS INC., Seoul (KR)

(21) Appl. No.: 15/121,977

(22) PCT Filed: Nov. 25, 2014
(86) PCT No.: PCT/KR2014/011359

§ 371 Date: Aug. 26, 2016

Related U.S. Application Data
(60) Provisional application No. 61/945,756, filed on Feb. 27, 2014.
(60) Provisional application No. 61/945,769, filed on Feb. 27, 2014.

(30) Foreign Application Priority Data
Sep. 30, 2014 (KR) 10-2014-0130810
Sep. 30, 2014 (KR) 10-2014-0131941

(51) Int. Cl. H04N 21/439; G10L 15/22; G10L 13/08; H04N 21/422; H04N 21/478

(52) U.S. Cl. CPC H04N 21/4394; H04N 21/42203; H04N 21/478; G10L 13/08; G10L 15/22; G10L 2015/223

(57) ABSTRACT

The present specification discloses a digital device and a control method therefor. Here, a digital device according to an embodiment of the present invention comprises: a pulse audio module for receiving, from an application, a first type audio data and a second type audio data different from the first type audio data; an audio processing unit; and an audio output unit, wherein the pulse audio module notifies the audio processing unit of the reception of the first and the second types of audio data, the audio processing unit controls the pulse audio module to adjust an output of the first and the second types of audio data on the basis of a policy associated with the first and second audio data, and the audio output unit outputs at least one of the first and second types of audio data on the basis of a result of the adjustment of the pulse audio module.

### TECHNICAL FIELD

The present invention relates to a digital device and a method of controlling therefor.

### BACKGROUND ART

Development of a mobile device such as a smartphone, a tablet PC, and the like as well as a standing device such as a PC (personal computer), a TV (television) is remarkable. The standing device and the mobile device have been originally developing in each domain in a manner of being distinguished. Yet, the domain becomes ambiguous according to the boom of recent digital convergence.

And, as an eye level of a user is getting higher according to the development of a digital device or environment change, demand for various and high-spec services and application support is increasing.

Meanwhile, as a function of a digital device is diversifying, a case of simultaneously outputting audio data corresponding to a plurality of contents frequently occurs. Hence, importance of an audio processing unit capable of controlling the audio data corresponding to a plurality of the contents in accordance with an intention of a user is gradually increasing.

### DISCLOSURE OF THE INVENTION

### Technical Tasks

Accordingly, the present invention is directed to substantially obviate one or more of the problems due to limitations and disadvantages of the related art. An object of the present invention is to provide a display device including an audio processing unit capable of controlling audio data corresponding to a plurality of contents when it is necessary to output the audio data at the same time.

Another object of the present invention is to provide a method of controlling a digital device capable of controlling audio data in accordance with an intention of a user when it is necessary to output the audio data at the same time.

Another object of the present invention is to enable a user to perform quick search on all contents of an application currently installed in a device using a search application.

Another object of the present invention is to enable a user to quickly and easily use contents preferred by the user by providing at least one or more content lists matched with text information inputted by the user via the search application.

The other object of the present invention is, if a user selects at least one or more contents from among content lists obtained by the search application, to make a user immediately use the contents by directly executing a specific application while a middle process is omitted.

Technical tasks obtainable from the present invention are non-limited the above mentioned technical tasks. And, other unmentioned technical tasks can be clearly understood from the following description by those having ordinary skill in the technical field to which the present invention pertains.

### Technical Solution

Various embodiment(s) for a digital device and a method of processing a service thereof are disclosed in the present specification.

To achieve these and other advantages and in accordance with the purpose of the present invention, as embodied and broadly described, according to one embodiment, a digital device includes a pulse audio module configured to receive audio data of a first type and audio data of a second type different from the first type from an application, an audio processing unit, and an audio output unit. In this case, the pulse audio module informs the audio processing unit of reception of the first and the second type audio data, the audio processing unit controls the pulse audio module to adjust outputs of the first and the second type audio data based on a policy related to the first and the second type audio data, and the audio output unit outputs at least one of the first type audio data and the second type audio data based on a result of the adjustment of the pulse audio module.

To further achieve these and other advantages and in accordance with the purpose of the present invention, according to one embodiment, a digital device includes a pulse audio module configured to receive audio data of a first type from an application, a TV service processing unit configured to receive audio data of a second type from an application, an audio processing unit, and an audio output unit. In this case, the pulse audio module informs the audio processing unit of reception of the first type audio data, the TV service processing unit informs the audio processing unit of reception of the second type audio data, the audio processing unit respectively controls the pulse audio module and the TV service module to adjust outputs of the first and the second type audio data based on a policy related to the first and the second type audio data, and the audio output unit outputs at least one of the first type audio data and the second type audio data based on a result of the adjustment of each of the pulse audio module and the TV service processing unit.

To further achieve these and other advantages and in accordance with the purpose of the present invention, according to one embodiment, a method of controlling a digital device includes the steps of receiving audio data of a first type and audio data of a second type different from the first type from an application via a pulse audio module, informing an audio processing unit of reception of the first and the second type audio data via the pulse audio module, controlling the pulse audio module to adjust outputs of the first and the second audio data based on a policy related to the first and the second type audio data via the audio processing unit, and outputting at least one of the first type audio data and the second type audio data via the audio output unit based on a result of the adjustment.

Technical solutions obtainable from the present invention are non-limited the above mentioned technical solutions. And, other unmentioned technical solutions can be clearly understood from the following description by those having ordinary skill in the technical field to which the present invention pertains.

### Advantageous Effects

Advantageous effects of the present invention are described in the following.

According to one embodiment among various embodiments of the present invention, it is able to provide a display device including an audio processing unit capable of controlling audio data corresponding to a plurality of contents when it is necessary to output the audio data at the same time.

According to a different embodiment among various embodiments of the present invention, it is able to provide a method of controlling a digital device capable of controlling audio data in accordance with an intention of a user when it is necessary to output the audio data corresponding to a plurality of contents at the same time.

According to one embodiment among various embodiments of the present invention, it is able to enable a user to perform quick search on all contents of an application currently installed in a device using a search application.

According to a different embodiment among various embodiments of the present invention, it is able to enable a user to quickly and easily use contents preferred by the user by providing at least one or more content lists matched with text information inputted by the user via the search application.

According to a further different embodiment among various embodiments of the present invention, if a user selects at least one or more contents from among content lists obtained by the search application, it is able to make the user immediately use the contents by directly executing a specific application while a middle process is omitted.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

FIG. 1 is a schematic diagram for explanation of a service system including a digital device according to an embodiment of the present invention;

FIG. 2 is a block diagram for explanation of a digital device according to an embodiment of the present invention;

FIG. 3 is a block diagram for explanation of a digital device according to another embodiment of the present invention;

FIG. 4 is a block diagram for explanation of a digital device according to another embodiment of the present invention;

FIG. 5 is a block diagram for explanation of detailed configurations of a controller of FIGS. 2 to 4 according to an embodiment of the present invention;

FIG. 6 is a diagram illustrating an inputter connected to the digital device of FIGS. 2 to 4 according to an embodiment of the present invention;

FIG. 7 is a diagram for explanation of a web OS architecture according to an embodiment of the present invention;

FIG. 8 is a diagram for explanation of an architecture of a web OS device according to an embodiment of the present invention;

FIG. 9 is a diagram for explanation of a graphic composition flow in a web OS device according to an embodiment of the present invention;

FIG. 10 is a diagram for explanation of a media server according to an embodiment of the present invention;

FIG. 11 is a diagram for explanation of a block diagram of a media server according to an embodiment of the present invention;

FIG. 12 is a diagram for explanation of a relationship between a media server and a TV service according to an embodiment of the present invention;

FIG. 13 is a block diagram for explaining a method of processing audio data in a digital device according to one embodiment of the present invention;

FIG. 14 is a diagram for explaining a method of activating a voice recognition function in a digital device according to one embodiment of the present invention;

FIG. 15 is a diagram for explaining an example of an operation of an audio processing unit when a voice recognition function of a digital device is activated according to one embodiment of the present invention;

FIG. 16 is a diagram for explaining a different example of an operation of an audio processing unit when a voice recognition function of a digital device is activated according to one embodiment of the present invention;

FIG. 17 is a diagram for explaining a further different example of an operation of an audio processing unit when a voice recognition function of a digital device is activated according to one embodiment of the present invention;

FIG. 18 is a diagram for explaining a further different example of an operation of an audio processing unit when a voice recognition function of a digital device is activated according to one embodiment of the present invention;

FIG. 19 is a diagram for explaining an example of an operation of an audio processing unit when an event related to a ringtone application occurs in a digital device according to one embodiment of the present invention;

FIG. 20 is a diagram for explaining an example of an operation of an audio processing unit when an event related to an alert application occurs in a digital device according to one embodiment of the present invention;

FIG. 21 is a diagram for explaining a different example of an operation of an audio processing unit when an event related to an alert application occurs in a digital device according to one embodiment of the present invention;

FIG. 22 is a block diagram for configuration modules of a digital device according to a different embodiment of the present invention;

FIG. 23 is a diagram for explaining a deep linking function supported by a digital device according to one embodiment of the present invention;

FIG. 24 is a diagram for explaining an example of receiving a text input using a search application in a digital device according to one embodiment of the present invention;

FIG. 25 is a diagram for explaining an example for a digital device to receive web application information and content information from a Meta server according to one embodiment of the present invention;

FIG. 26 is a diagram for explaining an example for a digital device to execute a deep linking function using a list received from a Meta server according to one embodiment of the present invention;

FIG. 27 is a diagram for explaining an example of using a search application in a digital device according to one embodiment of the present invention;

FIG. 28 is a diagram for explaining an example of processing a deep linking data in a digital device according to one embodiment of the present invention;

FIGS. 29 and 30 are diagrams for explaining an example for a digital device to generate a search list using a snapshot image according to one embodiment of the present invention; and

FIG. 31 is a flowchart for a method of controlling a digital device according to one embodiment of the present invention.

### BEST MODE

Description will now be given in detail according to exemplary embodiments disclosed herein, with reference to the accompanying drawings.

For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function.

In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Meanwhile, contents specified in the present disclosure or drawings are an embodiment of the present invention, so a scope of the present invention must be determined through a claim set.

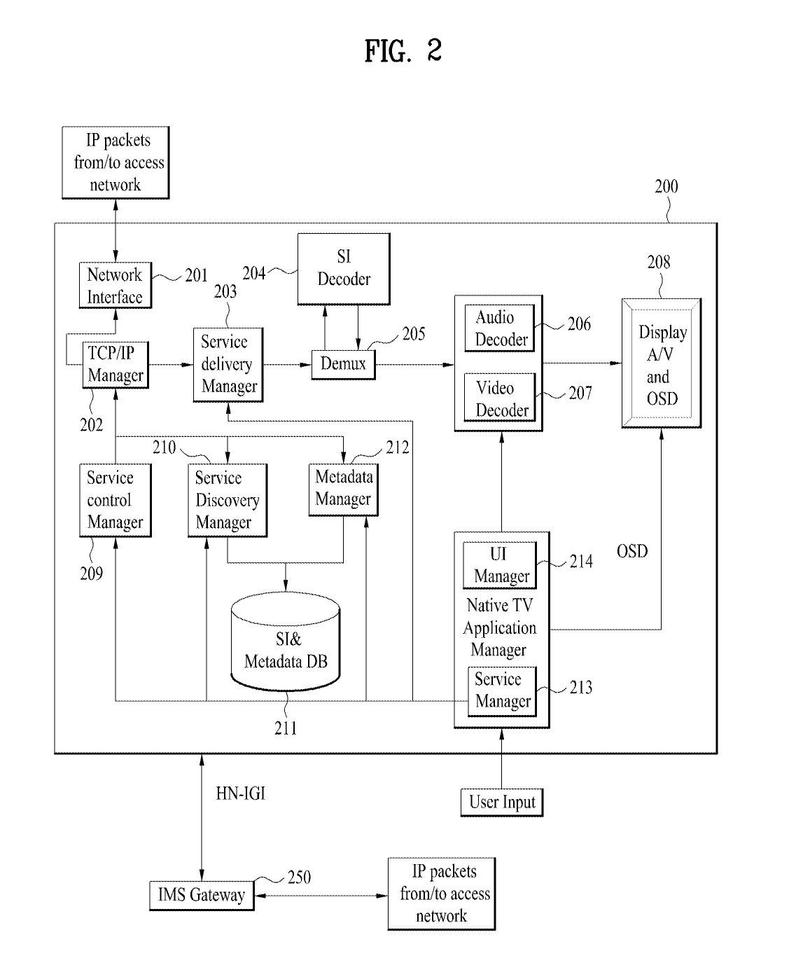

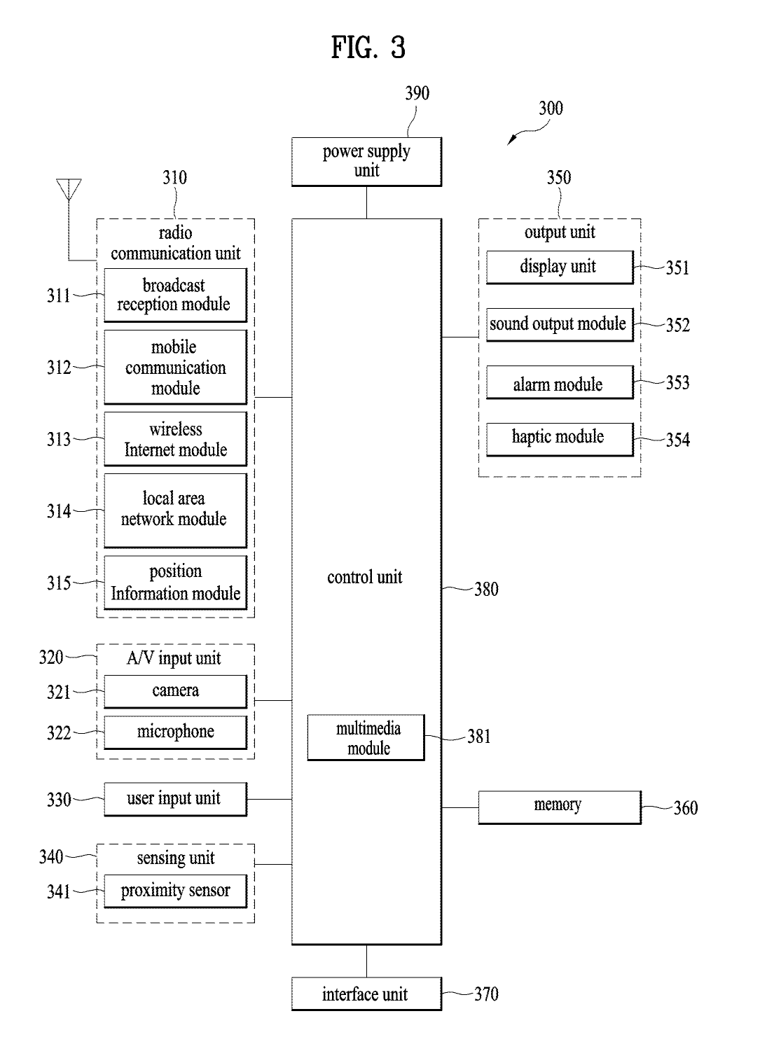

A digital device according to an embodiment of the present disclosure as set forth herein may be any device that can handle any one of transmitting, receiving, handling and outputting data, content, service, application, and so forth. The digital device may be connected to other digital devices through wired network or wireless network, paired or connected to an external server, and through the connections, the digital device may transmit and receive the prescribed data. Examples of the digital device may include standing devices such as a network television (TV), a Hybrid Broadcast Broadband TV (HBBTV), a smart TV, Internet Protocol TV (IPTV), and personal computer (PC), or mobile (or handheld) devices such as a Personal Digital Assistant (PDA), a smart phone, a tablet PC, or an Notebook computer. For convenience of description, in this disclosure, the Digital TV (DTV) is used in FIG. 2 and the mobile device is used in FIG. 3 depicting the digital device. Further, the digital device in this disclosure may be referred to configuration comprising only a panel, set-top box (STB), or a SET including the entire system.

Moreover, the wired/wireless network described in this disclosure may refer to various pairing methods, standard telecommunication network protocol methods which are supported for transmitting and receiving data between digital devices or between digital device and the external server. The wired or wireless network also includes various telecommunication network protocols supported now as well as in the future. Examples of the wired or wireless network include wired networks supported by various telecommunication standard such as Universal Serial Bus (USB), Composite Video Banking Sync (CVBS), Component, S-Video (analog), Digital Visual Interface (DVI), High Definition Multimedia Interface (HDMI), RGB, D-SUB and so forth, and wireless networks supported by various standards including Bluetooth™, Radio Frequency Identification (RFID), infrared Data Association (IrDA), Ultra Wideband (UWB), ZigBee, Digital Living Network Alliance (DLNA), Wireless LAN (WLAN) (Wi-Fi), Wireless broadband (Wibro), World Interoperability for Microwave Access (Wimax), High Speed Downlink Packet (HSDPA), Long Term Evolution/LTE-Advanced (LTE/LTE-A), Wi-Fi direct, and so forth.

In addition, the disclosure referring simply to the digital device can include a standing device or a mobile device depending on the context, and when it is not referred to a specific device, the digital device referred in this disclosure refers to both standing and mobile device.

Meanwhile, the digital device may perform intelligent functions such as receiving broadcasting program, operating computer functions, and supporting at least one external input, and by being connected through the network wired or wirelessly, the digital device may support e-mail functions, web browsing functions, banking, gaming, and executing applications. The digital device may further include an interface for any one of input or control means supporting a handwriting input, a touch-screen, and a spatial remote control.

Furthermore, the digital device may use a standard operating system (OS), however, the digital device described in this disclosure and the embodiments, uses a Web OS. Therefore, the digital device may perform functions such as adding, deleting, amending, and updating the various services and applications for standard universal OS kernel or Linux kernel in order to construct a more user-friendly environment.

When the digital device, described above, receives and handles external input, the external input includes external input devices described above, meaning all input mechanisms or digital devices, capable of transmitting and receiving data through wired or wireless network connected to and from the digital device. For example, the external input includes High Definition Multimedia Interface (HDMI), game devices such as Playstation or X-Box, smart phone, tablet PC, printing device such as pocket photo, digital devices such as smart TV and blue-ray device.

The “server” referred to as in this disclosure, includes a digital device or a system capable of transmitting and receiving data to and from a client, and may also be referred to as a processor. For example, the server may be servers providing services such as a portal server providing a web page, a web content or a web service, an advertising server providing advertising data, a content server, a Social Network Service (SNS) server providing a SNS service, a service server providing a service by a manufacturer, a Multichannel Video Programming Distributor (MVPD) providing a Video on Demand (VoD) or a streaming service, and a service server providing pay services.

When an application is described for the convenience of explanation, the meaning of disclosure in the context may include services as well as applications.

In the following description, various embodiments according to the present invention are explained with reference to attached drawings.

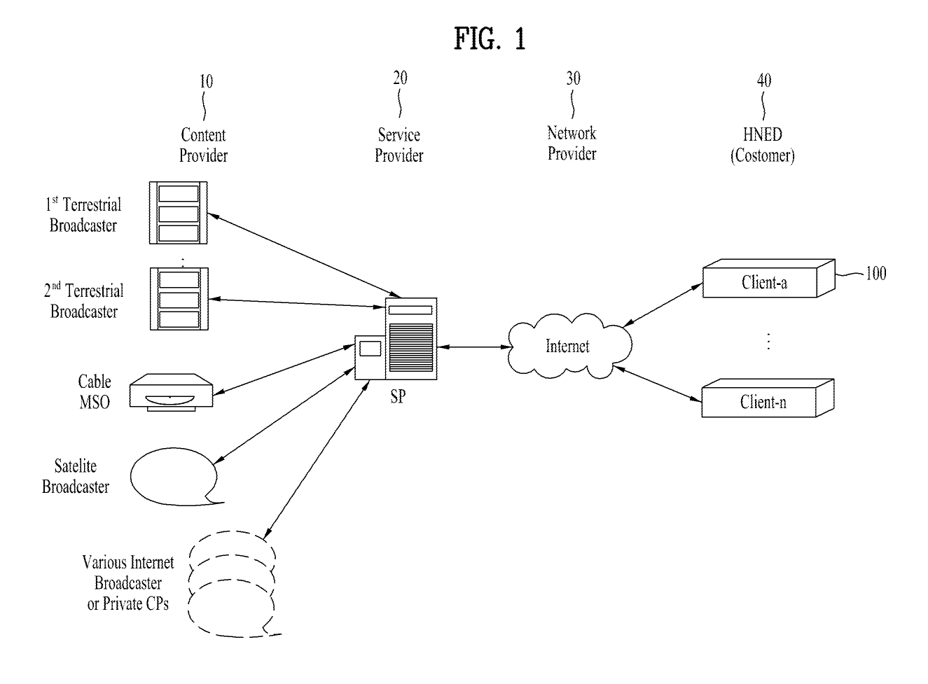

FIG. 1 illustrates a broadcast system including a digital device according to an embodiment of the present invention.

Referring to FIG. 1, examples of a broadcast system comprising a digital device may include a content provider (CP) 10, a service provider (SP) 20, a network provider (NP) 30, and a home network end user (HNED) (Customer) 40. The HNED 40 includes a client 100, that is, a digital device.

The CP 10 produces and provides content. Referring to FIG. 1, the CP 10 can include a terrestrial broadcaster, a cable system operator (SO) or multiple system operator (MSO), a satellite broadcaster, various Internet broadcasters, private content providers (CPs), etc. The CP 10 can provide various service or application web as well as broadcast content.

The SP 20 service-packetizes content produced by the CP 10. For example, the SP 20 packetizes at least one service among contents produced by a first terrestrial broadcaster, a second terrestrial broadcast, a cable MSO, a satellite broadcaster, various internet broadcasters, an application, etc. And, the SP 20 provides the packetized at least one service to the HNED 40.

The SP 20 can provide services to the client 100 in a uni-cast or multi-cast manner. The SP 20 can transmit data to a preregistered various clients 100 at once using an IGMP (Internet Group Management Protocol), etc.

The CP 10 and the SP 20 can be configured in the form of one entity. For example, the CP 10 can function as the SP 20 by producing content and directly packetizing the produced content into services, and vice versa.

The NP 30 can provide a network environment for data exchange between the server 10 and/or 20 and the client 100.

The client 100 is a consumer included in the HNED 40, construct a home network, receive data and transmit/receive data for various service or application like a VoD (video on demand), a streaming, and the like.

The CP 10 and/or SP 20 can use a content protection means or a conditional access for a content to be transmitted. In this case, the client 100 can use a means such as a cable card (CableCARD) (or a POD: Point of Deployment) or downloadable CAS (DCAS), which corresponds to the content protection means of the CP 10 and/or SP 20.

In addition, the client 100 can use an interactive service through a network. In this case, the client 100 can directly serve as the CP 10 and/or the SP 20 in a relationship with another client or indirectly function as a server of the other client.

In FIG. 1, the CP 10 and/or SP 20 may a server providing a service as below in this disclosure. In this case, if necessary, the server may include the NP 20. Although it is not described more specifically, the service or application can include not only service or application received from an external server also the service or application received from an internal memory. The service or application can include service or application data for the Client 100 based on a Web OS.

FIG. 2 is a schematic diagram of a digital device 200 according to an embodiment of the present invention.

Hereinafter, the digital device may correspond to the client 100 shown in FIG. 1.

The digital device 200 may include a network interface 201, a TCP/IP manager 202, a service delivery manager 203, an SI decoder 204, a demultiplexer 205, an audio decoder 206, a video decoder 207, a display A/V and OSD (On Screen Display) module 208, a service control manager 209, a service discovery manager 210, a SI & metadata database (DB) 211, a metadata manager 212, a service manager 213, a UI (user interface) manager, etc.

The network interface 201 may receive or transmit internet protocol (IP) packets or IP datagrams (hereinafter, IP packet(s)) through an accessed network. As an example, the network interface 201 may receive service, application, content and the like from the service provider 20 of FIG. 1 via the network.

The TCP/IP manager 202 may involve delivery of IP packets transmitted to the digital device 200 and IP packets transmitted from the digital device 200, that is, packet delivery between a source and a destination. The TCP/IP manager 202 may classify received packets according to an appropriate protocol and output the classified packets to the service delivery manager 205, the service discovery manager 210, the service control manager 209, and the metadata manager 212 and the like.

The service delivery manager 203 may control classification and processing of service data. The service delivery manager 203 may control real-time streaming data, for example, using real-time protocol/real-time control protocol (RTP/RTCP). In other words, the service delivery manager 203 may parse a real-time streaming data packet, transmitted on the basis of the RTP, according to the RTP and transmits the parsed data packet to the demultiplexer 205 or store the parsed data packet in the SI & metadata DB 211 under the control of the service manager 213. The service delivery manager 203 can feedback network reception information to the server on the basis of the RTP.

The demultiplexer 205 may demultiplex audio data, video data, SI from a received packet and transmit the demultiplexed data to the audio/video decoder 206/207 and the SI decoder 204, respectively.

The SI decoder 204 may decode the demultiplexed SI data such as program specific information (PSI), program and system information protocol (PSIP), digital video broadcast-service information (DVB-SI), digital television terrestrial multimedia broadcasting/coding mobile multimedia broadcasting (DTMB/CMMB), etc. The SI decoder 204 may store the parsed and/or decoded SI data in the SI&metadata DB 211. The SI data stored in the SI&metadata DB 211 can be read or extracted and used by a component which requires the SI data.

The audio decoder 206 and the video decoder 207 respectively may decode audio data and video data, which are demultiplexed by the demultiplexer 205. The decoded audio data and video data may be provided to the user through the display unit 208.

The application manager may include a service manager 213 and a UI manager 214, perform a function of a controller of the digital device 200. In other words, the application manager may administrate the overall state of the digital device 200, provide a UI, and manage other mangers.

The UI manager 214 can provide a graphic user interface (GUI)/UI through OSD, receive a key input from the user and provide a graphical user interface (GUI) related to a receiver operation corresponding to the key input through OSD. For instance, the UI manager 214 transmits the key input signal to the service manager 213 if the key input related to a channel selection from the user.

The service manager 213 may control and manage service-related managers such as the service delivery manager 203, the service discovery manager 210, the service control manager 209, the metadata manager 212, and the like.

The service manager 213 may configure a channel map and enable channel control at the request of the user on the basis of the channel map. The service manager 213 may receive service information corresponding to channel from the SI decoder 204 and set audio/video PID of a selected channel to the demultiplexer 205 so as to control the demultiplexing procedure of the demultiplexer 205.

The service discovery manager 210 may provide information required to select a service provider that provides a service. Upon receipt of a signal for selecting a channel from the service manager 213, the service discovery manager 210 discovers a service on the basis of the received signal.

The service control manager 209 may select and control a service. For example, the service control manager 209 may perform service selection and control using IGMP or real time streaming protocol (RTSP) when the user selects a live broadcast service and using RTSP when the user selects a VOD service. The schemes or protocols described in the specification are exemplified in order to aid in understanding of the present invention for convenience of explanations and the scope of the present invention is not limited thereto. Accordingly, the schemes or protocols can be determined in consideration of conditions different from the exemplified ones and other schemes or protocols can be used.

The metadata manager 212 may manage metadata regarding services and store metadata in the SI & metadata DB 211.

The SI & metadata DB 211 may store SI data decoded by the SI decoder 204, metadata managed by the metadata manager 212, and information required to select a service provider, which is provided by the service discovery manager 210. In addition, the SI & metadata DB 211 can store system set-up data.

The SI & metadata DB 211 can be implemented using a Non-Volatile RAM (NVRAM) or a Flash memory, and the like.

An IMS (IP Multimedia Subsystem) gateway 250 may include functions required to access an IMS based IPTV services.

FIG. 3 is a block diagram of a mobile terminal 300 in accordance with an embodiment of the present invention.

FIG. 2 specifies a standing device as an embodiment of the digital device, and FIG. 3 specifies a mobile terminal as another embodiment of the digital device.

With reference to FIG. 3, the mobile terminal 300 includes a wireless communication unit 310, an A/V (audio/video) input unit 320, a user input unit 330, a sensing unit 340, an output unit 350, a memory 360, an interface unit 370, a controller 380, a power supply unit 390, and the like.

Hereinafter, each element is specified as follows.

The wireless communication unit 310 typically includes one or more components which permit wireless communication between the mobile terminal 300 and a wireless communication system or network within which the mobile terminal 300 is located. For instance, the wireless communication unit 310 can include a broadcast receiving module 311, a mobile communication module 312, a wireless Internet module 313, a short-range communication module 314, and a position-location module 315.

The broadcast receiving module 311 receives a broadcast signal and/or broadcast associated information from an external broadcast managing server via a broadcast channel. The broadcast channel may include a satellite channel and a terrestrial channel. The broadcast managing server is generally a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and/or a data broadcast signal, among other signals. If desired, the broadcast signal may further include a broadcast signal combined with a TV or radio broadcast signal.

The broadcast associated information includes information associated with a broadcast channel, a broadcast program, or a broadcast service provider. Furthermore, the broadcast associated information can be provided via a mobile communication network. In this case, the broadcast associated information can be received by the mobile communication module 312.

The broadcast associated information can be implemented in various forms. For instance, broadcast associated information may include an electronic program guide (EPG) and an electronic service guide (ESG).

The broadcast receiving module 311 may be configured to receive broadcast signals transmitted from various types of broadcast systems. By non-limiting example, such broadcasting systems may include ATSC, DVB-T (Digital Video Broadcasting-Terrestrial), DVB-S(Satellite), media forward link only (MediaFLO™), integrated services digital broadcast-terrestrial (ISDB-T) and DTMB/CMMB. Optionally, the broadcast receiving module 311 can be configured to be suitable for other broadcasting systems as well as the above-noted digital broadcasting systems.

The broadcast signal and/or broadcast associated information received by the broadcast receiving module 311 may be stored in a suitable device, such as the memory 360.

The mobile communication module 312 transmits/receives wireless signals to/from at least one of a base station, an external terminal, or a server via a mobile network. Such wireless signals may carry audio, video, and data according to text/multimedia messages.

The wireless Internet module 313 includes wireless Internet access. This module may be internally or externally coupled to the mobile terminal 300. The wireless Internet technology can include Wi-Fi, Wibro™, Wimax™, HSDPA.

The short-range communication module 314 facilitates relatively short-range communications. Suitable technologies for implementing this module include Bluetooth™, radio frequency identification (RFID), infrared data association (IrDA), ultra-wideband (UWB), ZigBee™, RS-232, RS-485.

The position-location module 315 identifies or otherwise obtains the location of the mobile terminal 100. According to one embodiment, this module may be implemented with a global positioning system (GPS) module.

The audio/video (A/V) input unit 320 is configured to provide audio or video signal input to the mobile terminal 300. As shown, the A/V input unit 320 includes a camera 321 and a microphone 322. The camera 321 receives and processes image frames of still pictures or video, which are obtained by an image sensor in a video call mode or a photographing mode. Furthermore, the processed image frames can be displayed on the display 351.

The image frames processed by the camera 321 can be stored in the memory 360 or can be transmitted to an external recipient via the wireless communication unit 310. Optionally, at least two cameras 321 can be provided in the mobile terminal 300 according to the environment of usage.

The microphone 322 receives an external audio signal while the portable device is in a particular mode, such as phone call mode, recording mode and voice recognition. This audio signal is processed and converted into electronic audio data. The processed audio data is transformed into a format transmittable to a mobile communication base station via the mobile communication module 312 in a call mode. The microphone 322 typically includes assorted noise removing algorithms to remove noise generated in the course of receiving the external audio signal.

The user input unit 330 generates input data responsive to user manipulation of an associated input device or devices. Examples of such devices include a keypad, a dome switch, a touchpad (e.g., static pressure/capacitance), a jog wheel, and a jog switch.

The sensing unit 340 provides sensing signals for controlling operations of the mobile terminal 300 using status measurements of various aspects of the mobile terminal. For instance, the sensing unit 340 may detect an open/closed status of the mobile terminal 100, the relative positioning of components (e.g., a display and keypad) of the mobile terminal 300, a change of position (or location) of the mobile terminal 300 or a component of the mobile terminal 300, a presence or absence of user contact with the mobile terminal 300, and an orientation or acceleration/deceleration of the mobile terminal 300. As an example, a mobile terminal 300 configured as a slide-type mobile terminal is considered. In this configuration, the sensing unit 340 may sense whether a sliding portion of the mobile terminal is open or closed. According to other examples, the sensing unit 340 senses the presence or absence of power provided by the power supply unit 390, and the presence or absence of a coupling or other connection between the interface unit 370 and an external device. According to one embodiment, the sensing unit 340 can include a proximity sensor 341 including a near field communication (NFC), and the like.

The output unit 350 generates an output relevant to the senses of sight, hearing, and touch. Furthermore, the output unit 350 includes the display 351, an audio output module 352, an alarm unit 353, a haptic module 354, and a projector module 355.

The display 351 is typically implemented to visually display (output) information associated with the mobile terminal 300. For instance, if the mobile terminal is operating in a phone call mode, the display will generally provide a user interface (UI) or graphical user interface (GUI) which includes information associated with placing, conducting, and terminating a phone call. As another example, if the mobile terminal 300 is in a video call mode or a photographing mode, the display 351 may additionally or alternatively display images which are associated with these modes, the UI or the GUI.

The display module 351 may be implemented using known display technologies. These technologies include, for example, a liquid crystal display (LCD), a thin film transistor-liquid crystal display (TFT-LCD), an organic light-emitting diode display (OLED), a flexible display and a three-dimensional display. The mobile terminal 300 may include one or more of such displays.

Some of the displays can be implemented in a transparent or optical transmittive type, i.e., a transparent display. A representative example of the transparent display is the TOLED (transparent OLED). A rear configuration of the display 351 can be implemented as the optical transmittive type as well. In this configuration, a user may be able to see an object located at the rear of a terminal body on a portion of the display 351 of the terminal body.

At least two displays 351 can be provided in the mobile terminal 300 in accordance with one embodiment of the mobile terminal 300. For instance, a plurality of displays can be arranged to be spaced apart from each other or to form a single body on a single face of the mobile terminal 300. Alternatively, a plurality of displays can be arranged on different faces of the mobile terminal 300.

If the display 351 and a sensor for detecting a touch action (hereinafter called ‘touch sensor’) are configured as a mutual layer structure (hereinafter called ‘touch screen’), the display 351 is usable as an input device as well as an output device. In this case, the touch sensor can be configured as a touch film, a touch sheet, or a touchpad.

The touch sensor can be configured to convert pressure applied to a specific portion of the display 351 or a variation of capacitance generated from a specific portion of the display 351 to an electronic input signal. Moreover, the touch sensor is configurable to detect pressure of a touch as well as a touched position or size.

If a touch input is made to the touch sensor, a signal(s) corresponding to the touch input is transferred to a touch controller. The touch controller processes the signal(s) and then transfers the processed signal(s) to the controller 380. Therefore, the controller 380 is made aware when a prescribed portion of the display 351 is touched.

Referring to FIG. 3, a proximity sensor 341 can be provided at an internal area of the mobile terminal 300 enclosed by the touch screen or around the touch screen. The proximity sensor is a sensor that detects a presence or non-presence of an object approaching a prescribed detecting surface or an object existing (or located) around the proximity sensor using an electromagnetic field strength or infrared ray without mechanical contact. Hence, the proximity sensor 341 is more durable than a contact type sensor and also has utility broader than the contact type sensor.

The proximity sensor 341 can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, and an infrared proximity sensor. If the touch screen includes the electrostatic capacity proximity sensor, it is configured to detect the proximity of a pointer using a variation of an electric field according to the proximity of the pointer. In this configuration, the touch screen (touch sensor) can be considered as the proximity sensor.

For clarity and convenience of explanation, an action for enabling the pointer approaching the touch screen to be recognized as placed on the touch screen may be named ‘proximity touch’ and an action of enabling the pointer to actually come into contact with the touch screen may be named ‘contact touch’. And, a position, at which the proximity touch is made to the touch screen using the pointer, may mean a position of the pointer vertically corresponding to the touch screen when the pointer makes the proximity touch.

The proximity sensor detects a proximity touch and a proximity touch pattern (e.g., a proximity touch distance, a proximity touch duration, a proximity touch position, a proximity touch shift state). Information corresponding to the detected proximity touch action and the detected proximity touch pattern can be output to the touch screen.

The audio output module 352 functions in various modes including a call-receiving mode, a call-placing mode, a recording mode, a voice recognition mode, and a broadcast reception mode to output audio data which is received from the wireless communication unit 310 or is stored in the memory 360. During operation, the audio output module 352 outputs audio relating to a particular function (e.g., call received, message received). The audio output module 352 may be implemented using one or more speakers, buzzers, other audio producing devices, and combinations of these devices.

The alarm unit 353 outputs a signal for announcing the occurrence of a particular event associated with the mobile terminal 300. Typical events include a call received, a message received and a touch input received. The alarm unit 353 is able to output a signal for announcing the event occurrence by way of vibration as well as video or audio signal. The video or audio signal can be output via the display 351 or the audio output module 352. Hence, the display 351 or the audio output module 352 can be regarded as a part of the alarm unit 353.

The haptic module 354 generates various tactile effects that can be sensed by a user. Vibration is a representative one of the tactile effects generated by the haptic module 354. The strength and pattern of the vibration generated by the haptic module 354 are controllable. For instance, different vibrations can be output in a manner of being synthesized together or can be output in sequence. The haptic module 354 is able to generate various tactile effects as well as the vibration. For instance, the haptic module 354 may generate an effect attributed to the arrangement of pins vertically moving against a contact skin surface, an effect attributed to the injection/suction power of air though an injection/suction hole, an effect attributed to the skim over a skin surface, an effect attributed to a contact with an electrode, an effect attributed to an electrostatic force, and an effect attributed to the representation of a hot/cold sense using an endothermic or exothermic device. The haptic module 354 can be implemented to enable a user to sense the tactile effect through a muscle sense of a finger or an arm as well as to transfer the tactile effect through direct contact. Optionally, at least two haptic modules 354 can be provided in the mobile terminal 300 in accordance with an embodiment of the mobile terminal 300.

The memory 360 is generally used to store various types of data to support the processing, control, and storage requirements of the mobile terminal 300. Examples of such data include program instructions for applications operating on the mobile terminal 300, contact data, phonebook data, messages, audio, still pictures (or photo), and moving pictures. Furthermore, a recent use history or a cumulative use frequency of each data (e.g., use frequency for each phonebook, each message or each multimedia file) can be stored in the memory 360. Moreover, data for various patterns of vibration and/or sound output in response to a touch input to the touch screen can be stored in the memory 360.

The memory 360 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory or XD memory), or other similar memory or data storage device. Furthermore, the mobile terminal 300 is able to operate in association with a web storage for performing a storage function of the memory 360 on the Internet.

The interface unit 370 may be implemented to couple the mobile terminal 100 with external devices. The interface unit 370 receives data from the external devices or is supplied with power and then transfers the data or power to the respective elements of the mobile terminal 300 or enables data within the mobile terminal 300 to be transferred to the external devices. The interface unit 370 may be configured using a wired/wireless headset port, an external charger port, a wired/wireless data port, a memory card port, a port for coupling to a device having an identity module, audio input/output ports, video input/output ports, and/or an earphone port.

The identity module is a chip for storing various kinds of information for authenticating a usage authority of the mobile terminal 300 and can include a User Identify Module (UIM), a Subscriber Identity Module (SIM), and/or a Universal Subscriber Identity Module (USIM). A device having the identity module (hereinafter called ‘identity device’) can be manufactured as a smart card. Therefore, the identity device is connectible to the mobile terminal 300 via the corresponding port.

When the mobile terminal 300 is connected to an external cradle, the interface unit 370 becomes a passage for supplying the mobile terminal 300 with a power from the cradle or a passage for delivering various command signals input from the cradle by a user to the mobile terminal 300. Each of the various command signals input from the cradle or the power can operate as a signal enabling the mobile terminal 300 to recognize that it is correctly loaded in the cradle.

The controller 380 typically controls the overall operations of the mobile terminal 300. For example, the controller 380 performs the control and processing associated with voice calls, data communications, and video calls. The controller 380 may include a multimedia module 381 that provides multimedia playback. The multimedia module 381 may be configured as part of the controller 380, or implemented as a separate component. Moreover, the controller 380 is able to perform a pattern (or image) recognizing process for recognizing a writing input and a picture drawing input carried out on the touch screen as characters or images, respectively.

The power supply unit 390 provides power required by various components of the mobile terminal 300. The power may be internal power, external power, or combinations of internal and external power.

Various embodiments described herein may be implemented in a computer-readable medium using, for example, computer software, hardware, or some combination of computer software and hardware.

For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which performs one or more of the functions and operations described herein. The software codes can be implemented with a software application written in any suitable programming language and may be stored in memory such as the memory 160, and executed by a controller or processor, such as the controller 380.

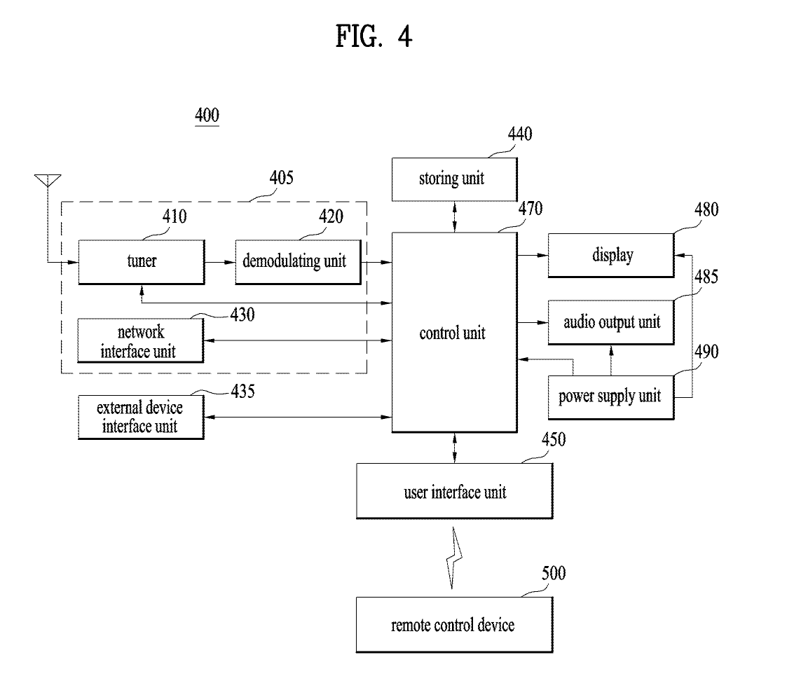

FIG. 4 illustrates a digital device according to another embodiment of the present invention.

Referring to FIG. 4, an exemplary digital device 400 according to the present invention may include a broadcast receiving unit 405, an external device interface 435, a storage unit 440, a user input interface 450, a controller 470, a display unit 480, an audio output unit 485, a power supply unit 490, and a photographing unit (not shown). The broadcast receiving unit 305 may include at least one of one or more tuner 410, a demodulator 420, and a network interface 430. The broadcast receiving unit 405 may include the tuner 410 and the demodulator 420 without the network interface 430, or may include the network interface 430 without the tuner 410 and the demodulator 420. The broadcast receiving unit 405 may include a multiplexer (not shown) to multiplex a signal, which is subjected to the tuner 410 and demodulated by the demodulator 420, and a signal received through the network interface 40. In addition, the broadcast receiving unit 405 can include a demultiplexer (not shown) and demultiplex a multiplexed signal, a demodulated signal, or a signal received through the network interface 430.

The tuner 410 may receive a radio frequency (RF) broadcast signal by tuning to a channel selected by the user from among RF broadcast signals received through an antenna or all previously stored channels.

For example, if the received RF broadcast signal is a digital broadcast signal, it is converted to a digital IF (DIF) signal, and if the received RF broadcast signal is an analog broadcast signal, it is converted to an analog baseband image or a voice signal (CVBS/SIF). That is, the tuner 410 can process both the digital broadcast signal and the analog broadcast signal. The analog baseband image or a voice signal output from the tuner 410 can be directly input to the controller 470.

The tuner 410 can receive a RF broadcast signal of single carrier or multiple carriers. The tuner 410 can sequentially tune and receive a RF broadcast signal of all broadcast channel stored by a channel memory function among RF broadcast signal received through an antenna to. And, the tuner 410 can convert the received RF broadcast signal into the DIF.

The demodulator 420 receives the DIF signal, demodulates the received DIF signal, and performs a channel decoding, etc. For this, the demodulator 420 includes a trellis decoder, a de-interleaver, a Reed-Solomon decoder, etc., or includes a convolution decoder, the de-interleaver, the Reed-Solomon decoder, etc.

The demodulator 420 can outputs a transport stream (TS) after performing a demodulation and a channel decoding. At this time, the TS signal can be a signal by multiplexing a video signal, an audio signal or a data signal. As an example, the TS signal can be an MPEG-2 TS by multiplexing an MPEG-2 standard video signal, a Dolby (AC-3 standard) audio signal, etc.

A TS signal output from the demodulator 420 may be input to the controller 470. The controller 470 can control demultiplexing, audio/video signal processing, etc. Furthermore, the controller 470 can control output of an image through the display unit 480 and output of audio through the audio output unit 485.

The external device interface 435 may provide an environment for interfacing external devices with the digital device 400. To implement this, the external device interface 435 may include an A/V input/output unit (not shown) or an RF communication unit (not shown).

The external device interface 435 can be connected with external devices such as a digital versatile disk (DVD), a Blu-ray player, a game device, a camera, a camcorder, a computer (including a notebook computer), a tablet PC, a smart phone, a Bluetooth device, a Cloud server and the like in a wired/wireless manner. The external device interface 435 transfer a signal to the controller 470 of the digital device. The signal includes image data, video data, audio data which is input through an external device. The external device is connected to the digital device. The controller 470 can control to output the signal including the processed image data, the processed video data and the processed audio data to the connected external device. For this, the external device interface 435 can further include an A/V input/output unit or a wireless communication unit (not shown).

The A/V input/output unit may include a USB (Universal Serial Bus) terminal, a composite video banking sync (CVBS) terminal, a component terminal, an S-video terminal (analog), a digital visual interface (DVI) terminal, a high definition multimedia interface (HDMI) terminal, an RGB terminal, a D-SUB terminal, etc.

The RF communication unit can perform near field communication. The digital device 400 can be networked with other electronic apparatuses according to communication protocols such as Bluetooth, radio frequency identification (RFID), infrared data association (IrDA), ultra wideband (UWB), ZigBee, and digital living network alliance (DLNA), for example.

Also, the external device interface 435 can connect a STB via at least one interface described above, and perform an input/output operation with the connected STB.

Meanwhile, the external device interface 435 can receive application or application list included in a nearby external device, and can transfer the application or the application list to the controller 470 or the storage unit 440.

The network interface 430 may provide an interface for connecting the digital device 400 with a wired/wireless network including an internet network. The network interface 430 can equip, for example, an Ethernet terminal to connect with a wired network and use a communication standard like wireless LAN (WLAN) (Wi-Fi), Wibro, Wimax, and HSDPA to connect with a wireless network.

The network interface 430 can transmit/receive data to/from other users or other electronic apparatuses or access a network connected thereto or another network linked to the connected network. Especially, the network interface 430 can transmit some content data stored in the digital device to another user pre-registered in the digital device 400, a user using another digital device or a selected digital device.

Meanwhile, the network interface 430 can access a web page through a connected network or another network linked to the connected network. That is, the network interface 430 can transmit/receive data to/from a corresponding server by accessing the web page through the network. Besides, the network interface 430 can receive content or data provided from a content provider or a network provider. That is, the network interface 430 can receive the content like a movie, an advertisement, a game, a VoD, a broadcast signal and related information provided from the content provider or network provider. And, the network interface 430 can receive firmware update information and an update file provided from the network provider. Also, the network interface 430 can transmit data to internet, content provider or network provider.

The network interface 430 can selectively receive a desired application from among publicly open applications through a network.

The storage unit 440 may store programs for signal processing and control and store a processed video, audio or data signal.

In addition, the storage unit 440 may execute a function of temporarily storing a video, audio or data signal input from the external device interface 435 or the network interface 430. The storage unit 440 may store information about a predetermined broadcast channel through a channel memory function.

The storage unit 440 can store an application or a list of applications input from the external device interface 435 or the network interface 430.

The storage unit 440 may store various platforms which will be described later.

The storage unit 440 can include storage media of one or more types, such as a flash memory type, a hard disk type, a multimedia card micro type, a card type memory (e.g. SD or XD memory), RAM, EEPROM, etc. The digital device 400 may reproduce content files (e.g., a video file, a still image file, a music file, a text file, an application file, etc.) and provide them to the user.

While FIG. 4 illustrates an embodiment in which the storage unit 440 is separated from the controller 470, the configuration of the digital device 400 is not limited thereto and the storage unit 440 may be included in the controller 470.

The user input interface 450 may transmit a signal input by the user to the controller 470 or deliver a signal output from the controller 470 to the user.

For example, the user input interface 450 can receive control signals such as a power on/off signal, a channel selection signal, an image setting signal, etc. from the remote controller 500 or transmit control signals of the controller 470 to the remote controller 500 according to various communication schemes such as RF communication, IR communication, and the like.

The user input interface 450 can transmit control signals input through a power key, a channel key, a volume key, and a local key (not shown) of a set value to the controller 470.

The user input interface 450 can transmit a control signal input from a sensing unit (not shown) which senses a gesture of the user or deliver a signal of the controller 470 to the sensing unit (not shown). Here, the sensing unit (not shown) may include a touch sensor, a voice sensor, a position sensor, an action sensor, an acceleration sensor, a gyro sensor, a speed sensor, a tilt sensor, a temperature sensor, a pressure or back-pressure sensor, etc.

The controller 470 can generate and output a signal for video or audio output by demultiplexing streams input through the tuner 410, the demodulator 420 or the external device interface 435 or processing demultiplexed signals.

A video signal processed by the controller 470 can be input to the display unit 480 and displayed as an image through the display unit 480. In addition, the video signal processed by the controller 470 can be input to an external output device through the external device interface 435.

An audio signal processed by the controller 470 can be applied to the audio output unit 485. Otherwise, the audio signal processed by the controller 470 can be applied to an external output device through the external device interface 435.

The controller 470 may include a demultiplexer and an image processor, which are not shown in FIG. 4.

The controller 470 can control the overall operation of the digital device 300. For example, the controller 470 can control the tuner 410 to tune to an RF broadcast corresponding to a channel selected by the user or a previously stored channel.

The controller 470 can control the digital device 400 according to a user command input through the user input interface 450 or an internal program. Particularly, the controller 470 can control the digital device 400 to be linked to a network to download an application or application list that the user desires to the digital device 400.

For example, the controller 470 may control the tuner 410 to receive a signal of a channel selected in response to a predetermined channel selection command received through the user input interface 450. In addition, the controller 470 may process a video, audio or data signal corresponding to the selected channel. The controller 470 may control information on a channel selected by the user to be output with a processed video or audio signal through the display unit 480 or the audio output unit 485.

Alternatively, the controller 470 may control a video signal or an audio signal received from an external apparatus, for example, a camera or a camcorder through the external device interface 435 to be output through the display unit 480 or the audio output unit 485 according to an external device image reproduction command received through the user input interface 450.

The controller 470 can control the display unit 480 to display images. For example, the controller 470 can control a broadcast image input through the tuner 410, an external input image received through the external device interface 435, an image input through the network interface 430, or an image stored in the storage unit 440 to be displayed on the display unit 480. Here, an image displayed on the display unit 480 can be a still image or video, and it can be a 2D or 3D image.

The controller 470 can control reproduction of content. Here, the content may be content stored in the digital device 400, received broadcast content, or content input from an external device. The content may include at least one of a broadcast image, an external input image, an audio file, a still image, an image of a linked web, and a text file.

The controller 470 can control display of applications or an application list, downloadable from the digital device 400 or an external network, when an application view menu is selected.

The controller 470 can control installation and execution of applications downloaded from an external network in addition to various user interfaces. Furthermore, the controller 470 can control an image relating to an application executed by user selection to be displayed on the display unit 480.

The digital device 400 may further include a channel browsing processor (not shown) which generates a thumbnail image corresponding to a channel signal or an external input signal.

The channel browsing processor can receive a stream signal (e.g., TS) output from the demodulator 420 or a stream signal output from the external device interface 435 and extract an image from the received stream signal to generate a thumbnail image. The generated thumbnail image can be directly input to the controller 470 or can be encoded and then input to the controller 470. Also, the thumbnail image can be coded into a stream and then applied to the controller 470. The controller 470 can display a thumbnail list including a plurality of thumbnail images on the display unit 480 using thumbnail images input thereto. The thumbnail images included in the thumbnail list can be updated sequentially or simultaneously. Accordingly, the user can conveniently check content of a plurality of broadcast channels.

The display unit 480 may convert a video signal, a data signal, and an OSD signal processed by the controller 470 and a video signal and a data signal received from the external device interface 435 into RGB signals to generate driving signals.

The display unit 480 may be a PDP, an LCD, an OLED, a flexible display, a 3D display or the like.

The display unit 480 may be configured as a touch-screen and used as an input device rather than an output device.

The audio output unit 485 receives a signal audio-processed by the controller 470, for example, a stereo signal, a 3.1 channel signal or a 5.1 channel signal, and outputs the received signal as audio. The audio output unit 485 can be configured as one of various speakers.

The digital device 400 may further include the sensing unit (not shown) for sensing a gesture of the user, which includes at least one of a touch sensor, a voice sensor, a position sensor, and an action sensor, as described above. A signal sensed by the sensing unit (not shown) can be delivered to the controller 470 through the user input interface 450.

The digital device 400 may further include the photographing unit (not shown) for photographing the user.

Image information acquired by the photographing unit (not shown) can be supplied to the controller 470. The controller 470 may sense a gesture of the user from an image captured by the photographing unit (not shown) or a signal sensed by the sensing unit (not shown), or by combining the image and the signal.

The power supply unit 490 may supply power to the digital device 400.

Particularly, the power supply unit 490 can supply power to the controller 470 which can be implemented as a system-on-chip (SoC), the display unit 480 for displaying images, and the audio output unit 485 for audio output.

For this, the power supply unit 490 can include a converter (not shown) converting a direct current to an alternative current. And, for example, if the display 480 is implemented as a crystal panel including a plurality of backlight lamps, the power supply unit can include an inverter (not shown) capable of performing a PWM (Pulse Width Modulation) operation to perform a changeable luminance or a dimming operation.

The remote controller 500 may transmit user input to the user input interface 450. To achieve this, the remote controller 500 can use Bluetooth, RF communication, IR communication, UWB, ZigBee, etc.

In addition, the remote controller 500 can receive audio, video or data signal output from the user input interface 350 and display the received signal or output the same as audio or vibration.

The digital devices shown in FIGS. 2 through 4 are a digital broadcast receiver which is capable of processing an ATSC or DVB digital broadcast signal for standing or mobile

Some of the components shown in FIG. 2 may be omitted or a component (not shown in FIG. 2) may be added as required. The digital device according to the present invention may not include the tuner and the demodulator, differently from the digital devices shown in FIGS. 2 and 4, and may receive content through the network interface or the external device interface and reproduce the content.

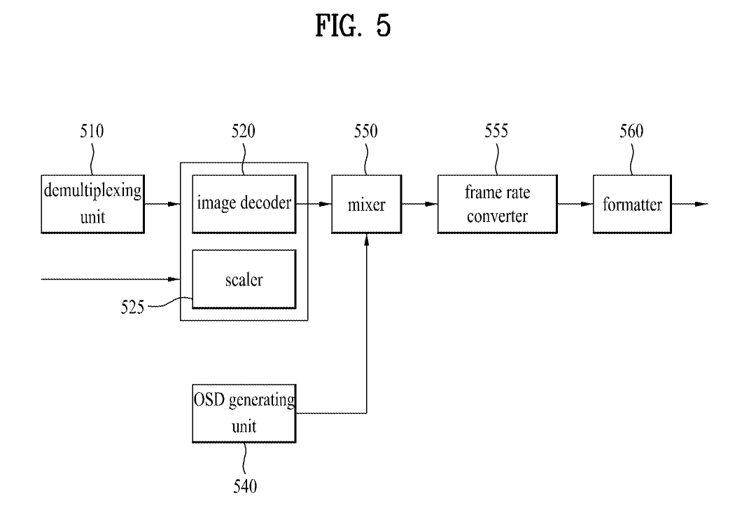

FIG. 5 is a block diagram for explanation of detailed configurations of a controller of FIGS. 2 to 4 according to an embodiment of the present invention.

An example of the controller may include a demultiplexer 510, an image processor 520, an OSD generator 540, a mixer 550, a frame rate converter (FRC) 555, and a 3D formatter (or an Output formatter) 560. The controller further includes a voice processing unit (not shown) and a data processing unit (not shown).

The demultiplexer 510 can demultiplex an input stream signal into an MPEG-2 TS image, an audio signal and a data signal, for example. Here, the stream signal inputted to the demultiplexer 510 is a stream signal output from a tuner, a demodulator or an external device interface.

The image processor 520 can process a demultiplexed image signal. For this, the image processor 520 includes a video decoder 525 and a scaler 535.

The video decoder 525 can decode the demultiplexed image signal and the scaler 535 can scale the resolution of the decoded image signal such that the image signal can be displayed.

The video decoder 525 can support various Standard. For instance, the video decoder 525 performs a function of MPEG-2 decoder if a video signal is coded with a MPEG-2 standard. And, the video decoder 525 performs a function of H.264/H.265 decoder if a video signal is coded with a DMB (Digital Multimedia Broadcasting) method or H.264/H.265 standard.

The image signal decoded by the image processor 520 may be input to the mixer 550.

The OSD generator 540 may generate OSD data automatically or according to user input. For example, the OSD generator 540 may generate data to be displayed on the screen of an output unit in the form of an image or text on the basis of a control signal of a user input interface. OSD data generated by the OSD generator 540 may include various data such as a user interface image of the digital device, various menu screens, widget, icons, and information on ratings. The OSD generator 540 can generate a caption of a broadcast image or data for displaying EPG based broadcast information.

The mixer 550 may mix the OSD data generated by the OSD generator 540 and the image signal processed by the image processor 520. The mixer 550 may provide the mixed signal to the 3D formatter 560. By mixing the decoded image signal and the OSD data, OSD may be overlaid on a broadcast image or external input image.

The frame rate converter (FRC) 555 may convert a frame rate of input video. For example, the frame rate converter 555 can convert the frame rate of an input 60 Hz video to a frame rate of 120 Hz or 240 Hz, according to an output frequency of the output unit. The frame rate converter 555 may be bypassed when frame conversion is not executed.

The formatter 560 may change the output of the frame rate converter 555, which is input thereto, into a form suitable for the output format of the output unit. For example, the 3D formatter 560 can output an RGB data signal. In this case, this RGB data signal can be output according to low voltage differential signaling (LVDS) or mini-LVDS. When a 3D image signal output from the frame rate converter 555 is input to the 3D formatter 560, the 3D formatter 560 can format the 3D image signal such that the 3D image signal is matched to the output format of the output unit, to thereby support a 3D service.

An audio processor (not shown) may audio-process a demultiplexed audio signal. The audio processor (not shown) can support various audio formats. For example, when audio signals are encoded in MPEG-2, MPEG-4, advanced audio coding (AAC), high efficiency-AAC (HE-AAC), AC-3 and bit sliced audio coding (BSAC) formats, the audio processor (not shown) can include decoders corresponding to the formats to process the audio signals.

Furthermore, the audio processor (not shown) can control base, treble and volume.

In addition, a data processor (not shown) can process a demultiplexed data signal. For example, when a demultiplexed data signal is encoded, the data processor (not shown) can decode the encoded demultiplexed data signal. Here, the encoded data signal may be EPG information including broadcast information such as the start time and end time (or duration) of a broadcast program which is broadcast through each channel.

The digital device is exemplary and components thereof can be integrated, added or omitted according to specifications thereof. That is, two or more components can be integrated into one component or one component can be subdivided into two or more components as required. The function executed by each component is exemplified to describe embodiments of the present invention and detailed operations or devices do not limit the scope of the present invention.

The digital device is an example of image signal processors which process an image stored therein or an input image. Other examples of the image signal processors may include a set-top box (STB) which does not include the display unit 380 and the audio output unit 485 shown in FIG. 4, a DVD player, a Blu-ray player, a game device, a computer, etc.

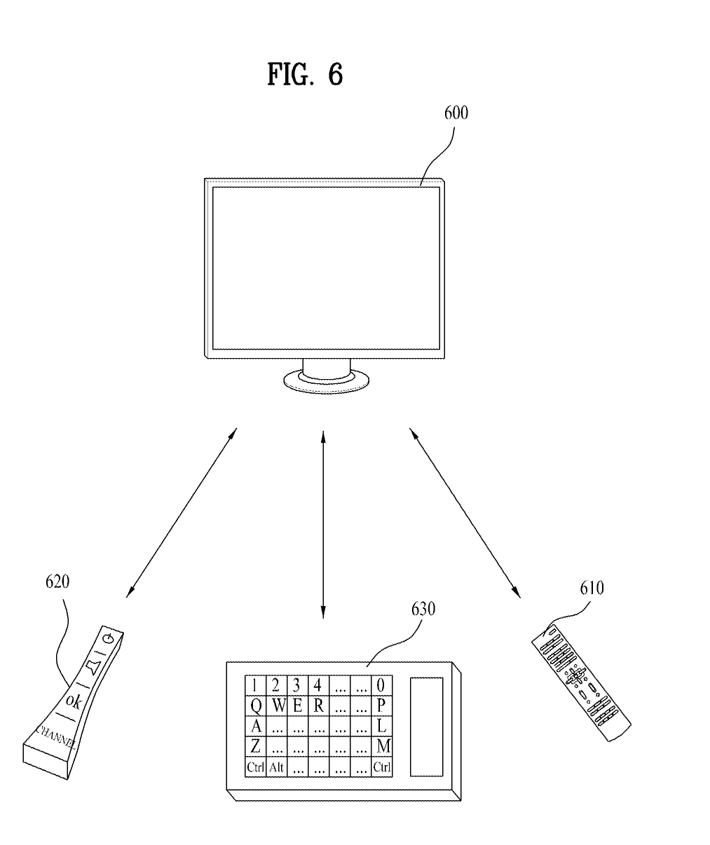

FIG. 6 illustrates remote controllers of a digital device according to an embodiment of the present invention.

To control the digital device, a front panel (not shown) equipped to the digital device 600 or control means (input means) is used.

Moreover, the control means is a user interface device (UID) capable of communicating with a wire/wireless communication, and includes a remote controller 610, a keyboard 630, a pointing device 620, a touch-pad for controlling the digital device 600. Further the control means includes a control mean dedicated to an external input which is connected to the digital device 600. Besides, the control means includes a mobile device like a smart phone and a tablet PC controlling the digital device 600 by switching a mode. Hereinafter, the present disclosure can specify the pointing device as an embodiment of the present invention.

The remote controllers can use various communication protocols such as Bluetooth, RFID, IrDA, UWB, ZigBee, DLNA, etc.

The remote controller 610 is a general input means including a various and necessary key buttons for controlling the digital device 600.

The pointing device 620 may include a gyro sensor mounted therein to sense vibration of a user's hand or rotation. That is, the pointing device 620 can move a pointer according to up, down, left and right motions of the user. The pointing device 620 is named to a magic remoter controller, a magic controller or the like.

The keyboard 630 UIDs can include a mobile device (e.g., a smart phone, a tablet PC, and the like), a magic remote controller 620 and a remote controller 630 equipped with a keyboard and a touch pad in addition to a general remote controller 610.

The remote controller 630 including the keyboard and touch pad can facilitate text input through the keyboard and control of movement of a pointer and magnification and reduction of a picture or video through the touch pad.

The digital device described in the present specification can be operated by based on Web OS platform. Hereinafter, a Web OS based process or algorithm may be performed by the controller of the above-described digital device. The controller includes the controllers of FIGS. 2 to 5 and has wide concepts. Accordingly, hereinafter, a component for processing Web OS based services, applications, content, etc., including software, firmware or hardware in a digital device is referred to a controller.

Such a Web OS based platform may improve development independency and functional extensibility by integrating services, applications, etc. based on a Luna-service bus, for example, and increase application development productivity based on web application framework. In addition, system resources, etc. may be efficiently used via a Web OS process and resource management to support multitasking.

A Web OS platform described in the present specification may be available or loaded not only for stationary devices such as personal computers (PCs), TVs and set top boxes (STBs) but also for mobile devices such as cellular phones, smartphones tablet PCs, laptops, and wearable devices.

A software structure for a digital device is a monolithic structure which solves conventional problems depending on markets, is a single process and closed product based on multi-threading, and has difficulties in terms of external applications. In pursuit of new platform based development, cost innovation via chipset replacement and UI application and external application development efficiency, layering and componentization are performed to obtain a 3-layered structure and an add-on structure for an add-on, a single source product and an open application. Recently, modular design of a software structure has been conducted in order to provide a web open application programming interface (API) for an echo system and modular architecture of a functional unit or a native open API for a game engine, and thus a multi-process structure based on a service structure has been produced.

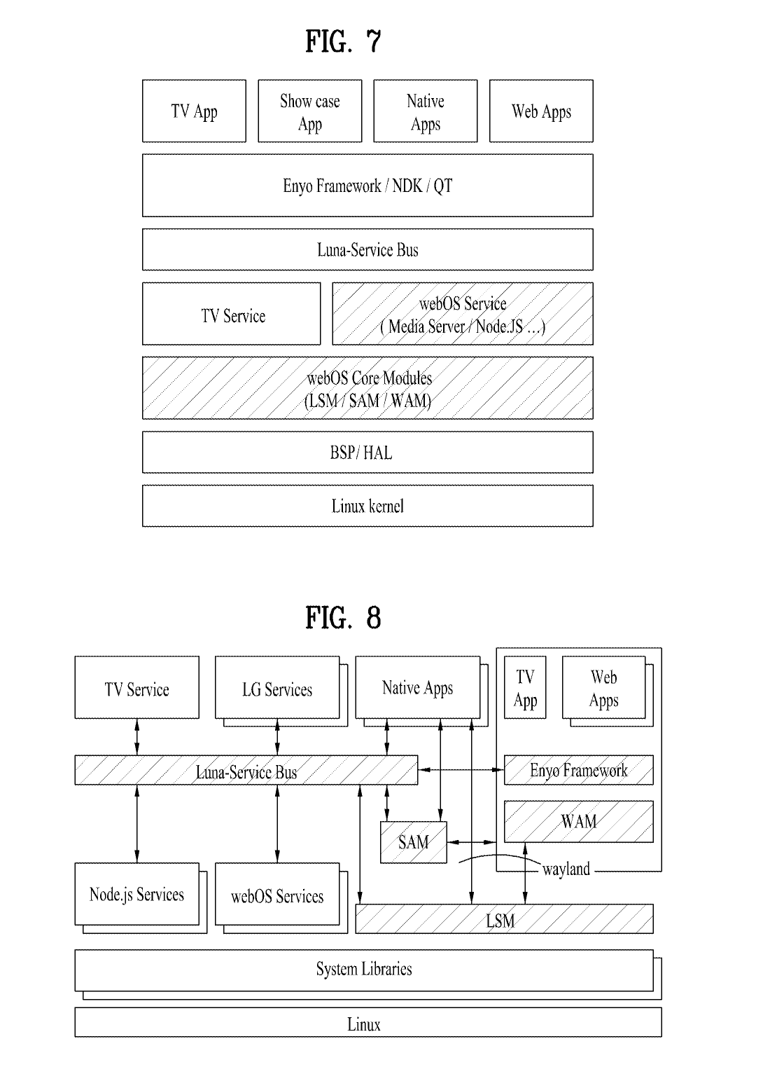

FIG. 7 is a diagram illustrating Web OS architecture according to one embodiment of the present invention.

The architecture of a Web OS platform will now be described with reference to FIG. 7.

The platform may be largely divided into a kernel, a Web OS core platform based on a system library, an application, a service, etc.

The architecture of the Web OS platform has a layered structure. OS is provided at a lowest layer, system library(s) are provided at a next highest layer and applications are provided at the highest layer.

First, the lowest layer is an OS layer including a Linux kernel such that Linux is included as an OS of the digital device.

At layers higher than the OS layer, a board support package (BSP)/hardware abstraction layer (HAL) layer, a Web OS core modules layer, a service layer, a Luna-service bus layer and an Enyo framework/native developer's kit (NDK)/QT layer are sequentially provided. At the highest layer, an application layer is provided.

One or more layers of the above-described Web OS layered structure may be omitted and a plurality of layers may be combined to one layer and one layer may be divided into a plurality of layers.

The Web OS core module layer may include a Luna surface manager (LSM) for managing a surface window, etc., a system & application manager (SAM) for managing execution and performance status of applications, etc., and a web application manager (WAM) for managing web applications based on WebKit.

The LSM manages an application window displayed on a screen. The LSM may control display hardware (HW) and provide a buffer for rendering content necessary for applications, and compose and output results of rendering a plurality of applications on a screen.

The SAM manages policy according to several conditions of systems and applications.

The WAM is based on Enyo framework, because a Web OS regards a web application as a basic application.

An application may use a service via a Luna-service bus. A service may be newly registered via a bus and the application may detect and use a desired service.

The service layer may include services having various service levels, such as a TV service, a Web OS service, etc. The Web OS service may include a media server, Node.JS, etc. and, in particular, the Node.JS service supports JavaScript, for example.

The Web OS service may be communicated to a Linux process implementing function logic via a bus. This Web OS service is largely divided into four parts, migrates from a TV process and an existing TV to a Web OS, is developed as services which differ between manufacturers, Web OS common services and Javascripts, and is composed of the Node.JS service used via Node.JS.

The application layer may include all applications supportable by a digital device, such as a TV application, a showcase application, a native application, a web application, etc.

Applications on the Web OS may be divided into a web application, a palm development kit (PDK) application, a Qt Meta Language or Qt Modeling Language (QML) application, etc. according to implementation methods.

The web application is based on a WebKit engine and is performed on WAM runtime. Such a web application is based on Enyo framework or may be developed and performed based on general HTML5, cascading style sheets (CSS) and Javascripts.

The PDK application includes a native application developed with C/C++ based on a PDK provided for a third party or an external developer. The PDK refers to a set of development libraries and tools provided to enable a third party to develop a native application (C/C++) such as games. For example, the PDK application may be used to develop applications requiring high performance.

The QML application is a native application based on Qt and includes basic applications provided along with the Web OS platform, such as card view, home dashboard, virtual keyboard, etc. QML is a markup language of a script format, not C++.

The native application is an application which is developed and compiled using C/C++ and is executed in the binary form and has an advantage such as high execution speed.

FIG. 8 is a diagram illustrating the architecture of a Web OS device according to one embodiment of the present invention.

FIG. 8 is a block diagram based on a runtime of a Web OS device and is described with reference to the layered structure of FIG. 7.

Hereinafter, a description will be given with reference to FIGS. 7 and 8.

Referring to FIG. 8, services, applications and Web OS core modules are included on a system OS (Linux) and system libraries and communication therebetween may be performed via a Luna-service bus.

Node.JS services based on HTML5 such as e-mail, contact or calendar, CSS, Javascript, etc., Web OS services such as logging, backup, file notify, database (DB), activity manager, system policy, audio daemon (AudioD), update, media server, etc., TV services such as electronic program guide (EPG), personal video recorder (PVR), data broadcasting, etc., CP services such as voice recognition, Now on, notification, search, auto content recognition (ACR), contents list browser (CBOX), wfdd, digital media remastering (DMR), remote application, download, Sony Philips digital interface format (SDPIF), etc., native applications such as PDK applications, browsers, QML applications, a UI-related TV applications based on Enyo framework and web applications are processed via Web OS core modules such as the above-described SAM, WAM and LSM via the Luna-service bus. The TV applications and the web applications are not necessarily based on Enyo framework or related to UI.

The CBOX may manage metadata and lists of content of external devices such as USB drivers, DLNA devices or Cloud servers connected to a TV. The CBOX may output content listing of various content containers such as USB, data management system (DMS), DVR, Cloud server, etc. as an integrated view. The CBOX may display various types of content listings such as pictures, music or video and manage metadata thereof. The CBOX may output content of an attached storage in real time. For example, if a storage device such as a USB is plugged in, the CBOX should immediately output a content list of the storage device. At this time, a standardized method for processing the content listing may be defined. The CBOX may accommodate various connection protocols.

The SAM is used to improve module complexity and extensibility. For example, an existing system manager processes several functions such as system UI, window management, web application runtime and UX constraint processing via one process and thus has high implementation complexity. In order to solve such a problem, the SAM divides main functions and clarifies an interface between functions, thereby decreasing implementation complexity.

The LSM is supported to independently develop and integrate a system UX such as card view, launcher, etc. and to easily cope with change in product requirements. The LSM maximally uses hardware resources to enable multitasking if a plurality of application screens is composed using an app-on-app method and may provide a window management mechanism for 21:9 and a multi-window.

The LSM supports implementation of a system UI based on a QML and improves development productivity. QML UX may easily configure a view using a screen layout and UI components based on model view controller (MVC) and easily develop code for processing user input. An interface between the QML and the Web OS component is achieved via a QML extensibility plug-in and graphic operation of an application may be based on Wayland protocol, luna-service call, etc.

The LSM is an abbreviation for a Luna surface manager and functions as an application window compositor.

The LSM composes and outputs independently developed applications, UI components, etc. on a screen. When components such as recent applications, showcase applications or launcher applications render respective content, the LSM defines an output area, a linkage method, etc. as a compositor. The LSM functioning as a compositor performs processing such as graphic composition, focus management, input events, etc. At this time, the LSM receives event, focus, etc. from an input manager, and a remote controller, a HID such as a mouse and keyboard, a joystick, a game pad, a remote application, a pen touch, etc. may be included as an input manager.

The LSM supports multiple window models and may be simultaneously executed in all applications as a system UI. The LSM may support launcher, Recents, setting, notification, system keyboard, volume UI, search, finger gesture, voice recognition (speech to text (STT), text to speech (TTS), natural language processing (NLP), etc.), pattern gesture (camera or mobile radio control unit (MRCU)), live menu, ACR, etc.

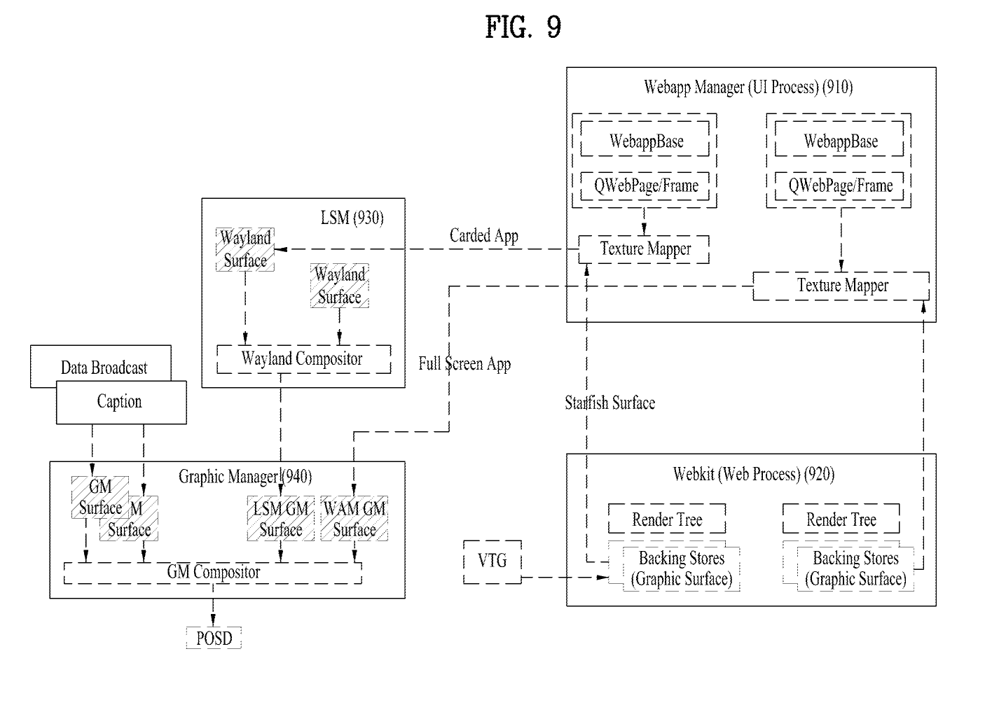

FIG. 9 is a diagram illustrating a graphic composition flow in a Web OS device according to one embodiment of the present invention.

Referring to FIG. 9, graphic composition processing may be performed via a web application manager 910 functioning as a UI process, a WebKit 920 functioning as a web process, an LSM 930 and a graphics manager (GM) 940.

When the web application manager 910 generates web application based graphics data (or application) as a UI process, the generated graphics data is delivered to the LSM if the graphics data is not a full-screen application. The web application manager 910 receives an application generated by the WebKit 920 in order to share a graphic processing unit (GPU) memory for graphic management between the UI process and the web process and delivers the application to the LSM 930 if the application is not a full-screen application. If the application is a full-screen application, the LSM 930 may bypass the application. In this case, the application is directly delivered to the graphics manager 940.

The LSM 930 transmits the received UI application to a Wayland compositor via a Wayland surface and the Wayland compositor appropriately processes the UI application and delivers the processed UI application to the graphics manager. The graphics data received from the LSM 930 is delivered to the graphics manager compositor via the LSM GM surface of the graphics manager 940, for example.

The full-screen application is directly delivered to the graphics manager 940 without passing through the LSM 930 as described above and is processed in the graphics manager compositor via the WAM GM surface.

The graphics manager processes and outputs all graphics data in the Web OS device and receives and outputs data passing through the above-described LSM GM surface, data passing through a WAM GM surface, and graphics data passing through a GM surface, such as a data broadcasting application or a caption application, on a screen. The function of the GM compositor is equal or similar to the above-described compositor.

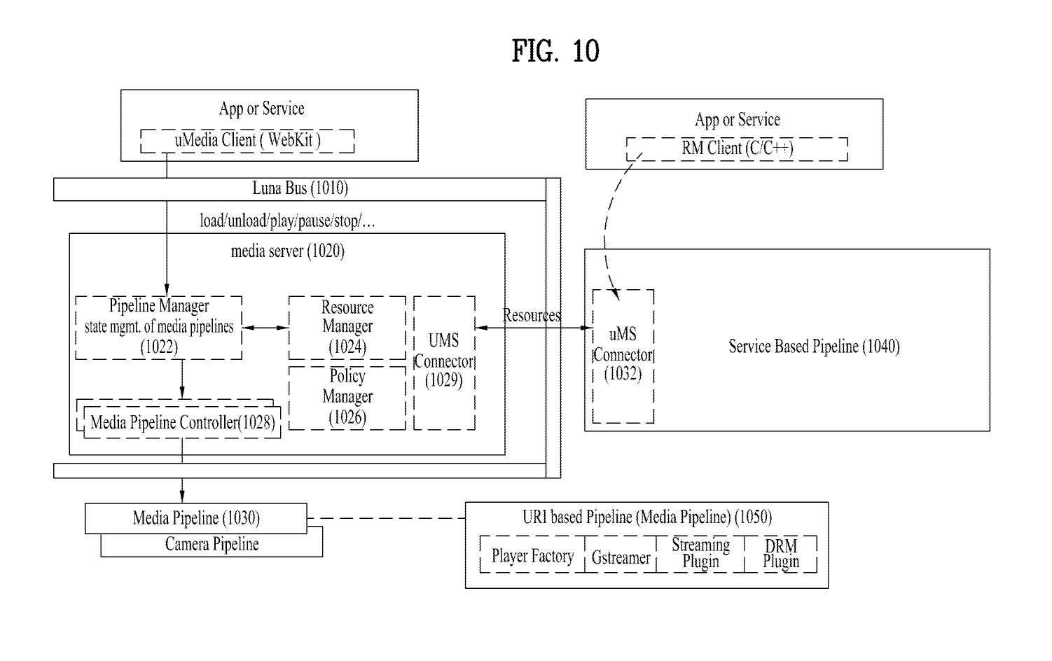

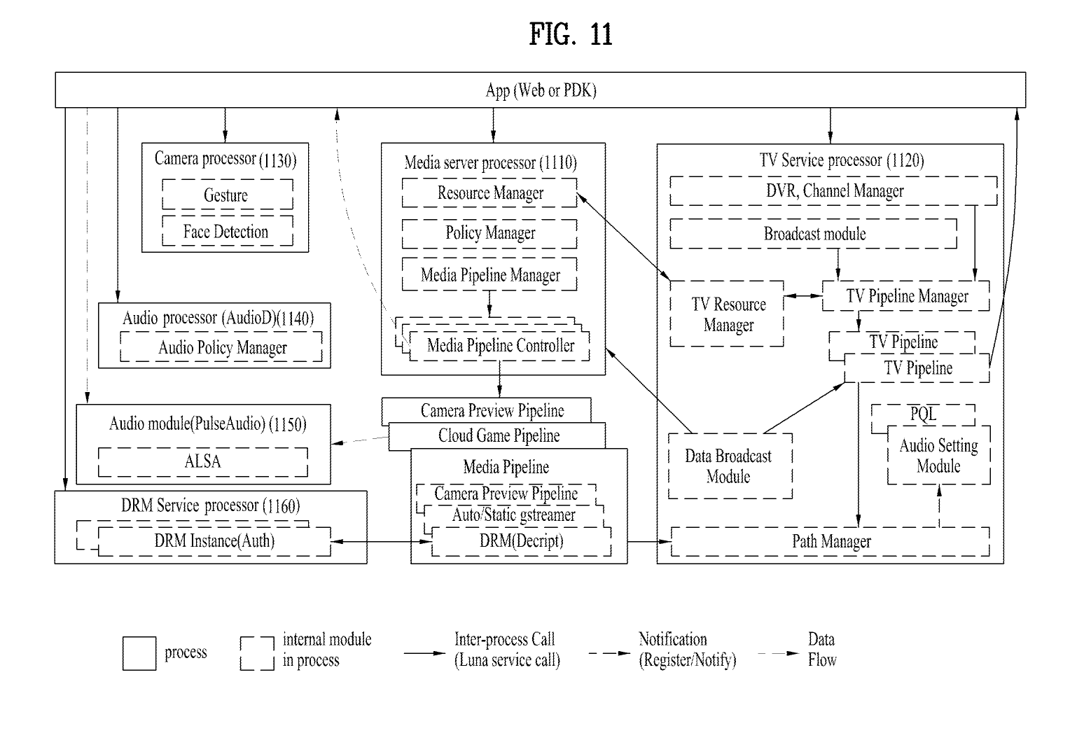

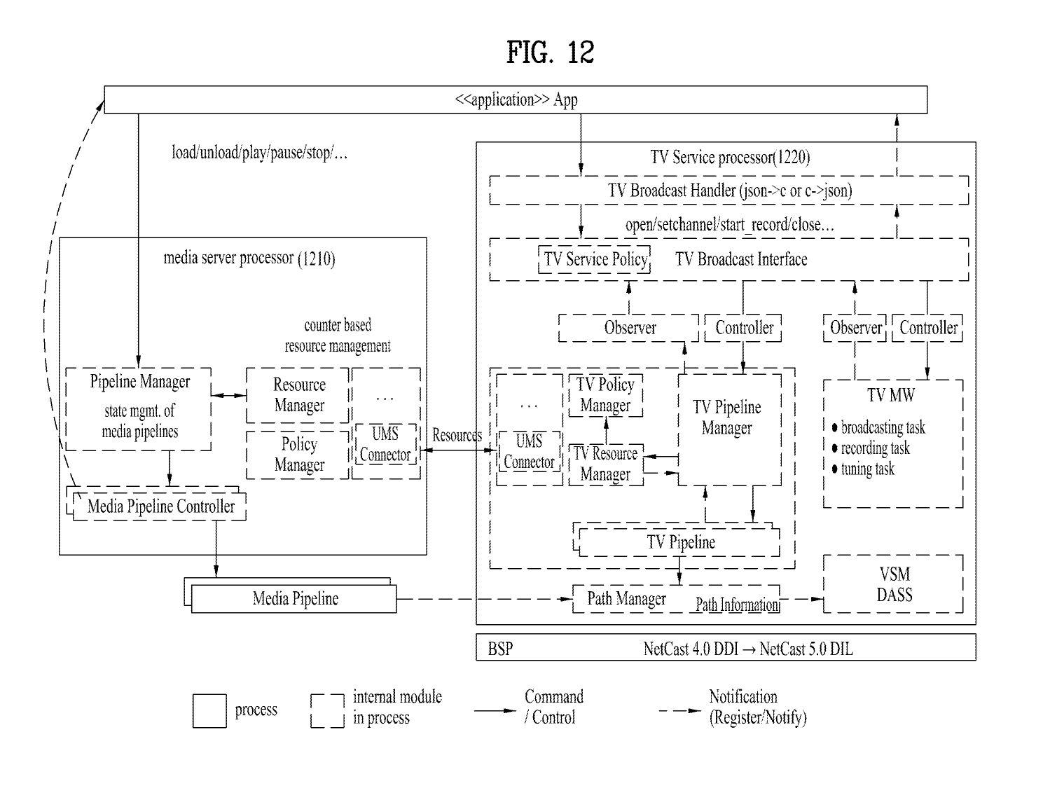

FIG. 10 is a diagram illustrating a media server according to one embodiment of the present invention, FIG. 11 is a block diagram of a media server according to one embodiment of the present invention, and FIG. 12 is a diagram illustrating a relationship between a media server and a TV service according to one embodiment of the present invention.

The media server supports execution of a variety of multimedia in a digital device and manages necessary resources. The media server may efficiently use hardware resources necessary for media play. For example, the media server requires audio/video hardware resources for multimedia execution and efficiently manages a resource use status to efficiently use resources. In general, a stationary device having a screen larger than that of a mobile device requires more hardware resources upon multimedia execution and requires high encoding/decoding rate and graphics data transfer rate due to a large amount of data. The media server should perform not only streaming or file playback but also broadcasting, recording and tuning tasks, a task for simultaneously viewing and recording, and a task for simultaneous displaying a sender and a recipient on a screen upon video call. It is difficult for the media server to simultaneously perform several tasks due to restriction in hardware resources such as an encoder, a decoder, a tuner, a display engine, etc. in chipset units. For example, the media server restricts a use scenario or performs processing using user input.

The media server may make system stability robust, and may remove a playback pipeline, in which errors occur during media playback, per pipeline, such that other media play is not influenced even when errors occur. Such a pipeline is a chain for connecting unit functions such as decoding, analysis, output, etc. upon a media playback request, and required unit functions may be changed according to media type, etc.

The media server may have extensibility and may add a new type of pipeline without influencing an existing implementation method. For example, the media server may accommodate a camera pipeline, a video conference (e.g., Skype) pipeline, a third-party pipeline, etc.

The media server may process general media playback and TV task execution as separate services because the interface of the TV service is different from that of media playback. The media server supports operation such as “setchannel”, “channelup”, “channeldown”, “channeltuning” and “recordstart” in relation to the TV service and support operation such as “play”, “pause” and “stop” in relation to general media playback, that is, supports different operations with respect to the TV service and general media playback and processes the TV service and media playback as separate services.

The media server may control or manage a resource management function. Hardware resource assignment or recovery in a device is conducted by the media server. In particular, the TV service process delivers a task which is being executed and a resource assignment status to the media server. The media server secures resources to execute a pipeline whenever media is executed, allows media execution due to priority (e.g., policy) upon media execution request, and performs resource recovery of another pipeline, based on a resource status of each pipeline. The predefined execution priority and resource information necessary for a specific request are managed by a policy manager and the resource manager communicates with the policy manager to process resource assignment and recovery.

The media server may have identifiers (IDs) for all operations related to playback. For example, the media server may send a command to a specific pipeline based on the ID. The media server may send respective commands to pipelines for playback of two or more media.

The media server is responsible for playing back a HTML5 standard media.

The media server performs a service process of a TV pipeline according to a TV restructuralization range. The media server may be designed and implemented regardless of the TV restructuralization range. If the separate service process of the TV is not performed, the TV may be wholly re-executed when errors occurs in a specific task.

The media server is also referred to as uMS, that is, a micro media server. The media player is a media client and means WebKit for HTML5 video tag, camera, TV, Skype or second screen, for example.

The media server mainly manages micro resources such as a resource manager or a policy manager. The media server also controls playback of web standard media content. The media server may manage pipeline controller resources.

The media server supports extensibility, reliability, efficient resource usage, etc., for example.

In other words, the uMS, that is, the micro media server, manages and controls resource usage for appropriate processing within the Web OS device, such as resources such as cloud game, MVPD (pay service, etc.), camera preview, second screen or Skype, and TV resources. A pipeline is used upon usage of each resource, for example, and the media server may manage and control generation, deletion, use of a pipeline for resource management.

The pipeline may be generated when a media related to a task starts a sequence of request, decoding streaming and parsing such as video output. For example, in association with a TV service and an application, watching, recording, channel tuning, etc. are controlled and performed via pipelines individually generated according to requests thereof with respect to resource usage.

Referring to FIG. 10, a processing structure of a media server will be described in detail.

In FIG. 10, an application or service is connected to a media server 1020 via a Luna-service bus 1010 and the media server 1020 is connected to and managed by pipelines generated via the Luna-service bus 1010.

The application or service includes various clients according to properties thereof and may exchange data with the media server 1020 or the pipeline via the clients.

The clients include a uMedia client (WebKit) for connection with the media server 1020 and a resource manager (RM) client (C/C++), for example.

The application including the uMedia client is connected to the media server 1020 as described above. More specifically, the uMedia client corresponds to the below-described video object, for example, and uses the media server 1020, for video operation by a request, etc.

The video operation relates to a video status and may include all status data related to the video operation, such as loading, unloading, play (playback or reproduction), pause, stop, etc. Such video operations or statuses may be processed by generating individual pipelines. Accordingly, the uMedia client transmits status data related to the video operation to the pipeline manager 1022 in the media server.

The media server 1022 acquires information about resources of the current device via data communication with the resource manager 1024 and requests assignment of resources corresponding to the status data of the uMedia client. At this time, the pipeline manager 1022 or the resource manager 1024 controls resource assignment via data communication with the policy manager 1026 if necessary. For example, if resources to be assigned according to the request of the pipeline manager 1022 are not present or are lacking in the resource manager 1024, resource assignment may be appropriately performed according to priority comparison of the policy manager 1026.

The pipeline manager 1022 requests to generate a pipeline for operation according to the request of the uMedia client from the media pipeline controller 102, with respect to resources assigned according to resource assignment of the resource manager 1024.

The media pipeline controller 1028 generates a necessary pipeline under control of the pipeline manager 1022. As shown, a media pipeline, a camera pipeline, a pipeline related to playback, pause or stop may be generated. The pipeline includes pipelines for HTML5, web CP, Smartshare playback, thumbnail extraction, NDK, cinema, multimedia and hypermedia information coding experts group (MHEG), etc.

The pipeline may include a service-based pipeline and a URI based pipeline (media pipeline), for example.

Referring to FIG. 10, the application or service including the RM client may not be directly connected to the media server 1020, because the application or service can directly process a media. In other words, if the application or service directly processes a media, the media server may not be used. At this time, for pipeline generation and usage, resource management is necessary and, at this time, a uMS connector is used. When a resource management request for direct media processing of the application or service is received, the uMS connector communicates with the media server 1020 including the resource manager 1024. The media server 1020 also includes a uMS connector.

Accordingly, the application or service may cope with the request of the RM client via resource management of the resource manager 1024 via the uMS connector. The RM client may process services such as native CP, TV service, second screen, flash player, You Tube media source extensions (MSE), cloud game, Skype, etc. In this case, as described above, the resource manager 1024 may manage resources via appropriate data communication with the policy manager 1026 if necessary for resource management.

The URI based pipeline does not directly process the media unlike the above-RM client but processes the media via the media server 1020. The URI based pipeline may include player factory, Gstreamer, streaming plug-in, digital rights management (DRM) plug-in pipelines.

An interface method between the application and the media services is as follows.

An interface method using a service in a web application may be used. In this method, a Luna call method using a palm service bridge (PSB) and a method of using Cordova may be used, in which a display is extended to a video tag. In addition, a method of using HTML5 standard related to a video tag or media element may be used.

A method of using a service in PDK may be used.

Alternatively, a method of using in existing CP may be used. For backward compatibility, plug-in of an existing platform may be extended and used based on Luna.

Lastly, an interface method using a non-Web OS may be used. In this case, a Luna bus may be directly called to perform interfacing.

Seamless change is processed by a separate module (e.g., TVwin) and refers to a process of first displaying a TV program on a screen without a Web OS before or duration Web OS booting and then performing seamless processing. This is used for the purpose of first providing a basic function of a TV service, for fast response to a power-on request of a user, because a booting time of a Web OS is late. The module is a part of a TV service process and supports seamless change for providing fast booting and a basic TV function, factory mode, etc. The module is responsible for switching from the non-Web OS mode to the Web OS mode.

FIG. 11 shows the processing structure of the media server.

In FIG. 11, a solid box denotes a process component and a dotted box denotes an internal processing module of the process. A solid arrow denotes an inter-process call, that is, a Luna-service call and a dotted arrow denotes notification such as register/notify or data flow.

The service, the web application or the PDK application (hereinafter, referred to as “application”) is connected to various service processing components via a Luna-service bus and is operated or controlled via the service processing components.

A data processing path is changed according to application type. For example, if the application includes image data related to a camera sensor, the image data is transmitted to and processed by a camera processor 1130. At this time, the camera processor 1130 includes a gesture or face detection module and processes image data of the received application. The camera processor 1130 may generate a pipeline via a media server processor 1110 with respect to data which requires use of a pipeline according to user selection or automatically and process the data.

Alternatively, if the application includes audio data, the audio may be processed via an audio processor (AudioD) 1140 and an audio module (PulseAudio) 1150. For example, the audio processor 1140 processes the audio data received from the application and transmits the processed audio data to the audio module 1150. At this time, the audio processor 1140 may include an audio policy manager to determine processing of the audio data. The processed audio data is processed by the audio module 1150. The application or a pipeline related thereto may notify the audio module 1150 of data related to audio data processing. The audio module 1150 includes advanced Linux sound architecture (ALSA).

Alternatively, if the application includes or processes (hereinafter, referred to as “includes”) content subjected to DRM, the content data is transmitted to a DRM service processor 1160 and the DRM service processor 1160 generates a DRM instance and processes the content data subjected to DRM. The DRM service processor 1160 is connected to a DRM pipeline in a media pipeline via a Luna-service bus, for processing of the content data subjected to DRM.

Hereinafter, processing of an application including media data or TV service data (e.g., broadcast data) will be described.

FIG. 12 shows the media server processor and the TV service processor of FIG. 11 in detail.

Accordingly, a description will be given with reference to FIGS. 11 and 12.

First, if the application includes TV service data, the application is processed by the TV service processor 1120/1220.

The TV service processor 1120 includes at least one of a DVR/channel manager, a broadcast module, a TV pipeline manager, a TV resource manager, a data broadcast module, an audio setting module, a path manager, etc., for example. In FIG. 12, the TV service processor 1220 may include a TV broadcast handler, a TV broadcast interface, a service processor, TV middleware (M/W), a path manager and a BSP (NetCast). The service processor may mean a module including a TV pipeline manager, a TV resource manager, a TV policy manager, a USM connector, etc., for example.

In the present disclosure, the TV service processor may have the configuration of FIG. 11 or FIG. 12 or a combination thereof. Some components may be omitted or other components (not shown) may be added.

The TV service processor 1120/1220 transmits DVR or channel related data to a DVR/channel manager and transmits the DVR or channel related data to the TV pipeline manager to generate and process a TV pipeline, based on attribute or type of the TV service data received from the application. If the attribute or type of the TV service data is broadcast content data, the TV service processor 1120 generates and processes a TV pipeline via the TV pipeline manager, for processing of the data via a broadcast module.

Alternatively, a JavaScript standard object notation (json) file or a file written in c is processed by the TV broadcast handler and transmitted to the TV pipeline manager via a TV broadcast interface to generate and process a TV pipeline. In this case, the TV broadcast interface may transmit the data or file passing through the TV broadcast handler to the TV pipeline manager based on TV service policy and refer to the data or file upon generating a pipeline.

The TV pipeline manager generates one or more pipelines according to a request for generation of a TV pipeline from the processing module or manager of the TV service processor, under control of the TV resource manager. The TV resource manager may be controlled by the TV policy manager, in order to request a resource assignment status for a TV service according to a request for generation of a TV pipeline of the TV pipeline manager, and may perform data communication with the media server processor 1110/1210 via a uMS connector. The resource manager in the media server processor 1110/1210 sends the resource assignment status for the TV service according to the request of the TV resource manager. For example, if the resource manager in the media server processor 1110/1210 determines that the resources for the TV service are already assigned, the TV resource manager may be notified that assignment of all resources is completed. At this time, the resource manager in the media server processor may remove a predetermined TV pipeline according to a predetermined criterion or priority of TV pipelines already assigned for the TV service along with notification and request generation of a TV pipeline for the requested TV service. Alternatively, the TV resource manager may appropriately remove a TV pipeline or may add or newly establish a TV pipeline according to a status report of the resource manager in the media server processor 1110/1210.

The BSP supports backward compatibility with an existing digital device.

The generated TV pipelines may appropriately operate under control of the path manager in the processing procedure. The path manager may determine or control the processing path or procedure of the pipelines in consideration of the TV pipeline in the processing procedure and the operation of the pipelines generated by the media server processor 1110/1210.

Next, if the application includes media data, not TV service data, the application is processed by the media server processor 1110/1210. The media server processor 1110/1210 includes a resource manager, a policy manager, a media pipeline manager, a media pipeline controller, etc. As pipelines generated under control of the media pipeline manager and the media pipeline controller, a camera preview pipeline, a cloud game pipeline, a media pipeline, etc. may be generated. The media pipeline may include streaming protocol, auto/static gstreamer, DRM, etc. and the processing flow thereof may be determined under control of the path manager. For a detailed description of the processing procedure of the media server processor 1110/1210, refer to the description of FIG. 10 and a repeated description will be omitted. In the present specification, the resource manager in the media server processor 1110/1210 may perform resource management to a counter base, for example.

In the disclosure, the resource manager included in the media server processor 1110/1210, for instance, can manage the resource using a counter base.

In the following, various embodiments for a method of processing audio data in a digital device are explained in more detail with reference to the attached drawing according to one embodiment of the present invention.

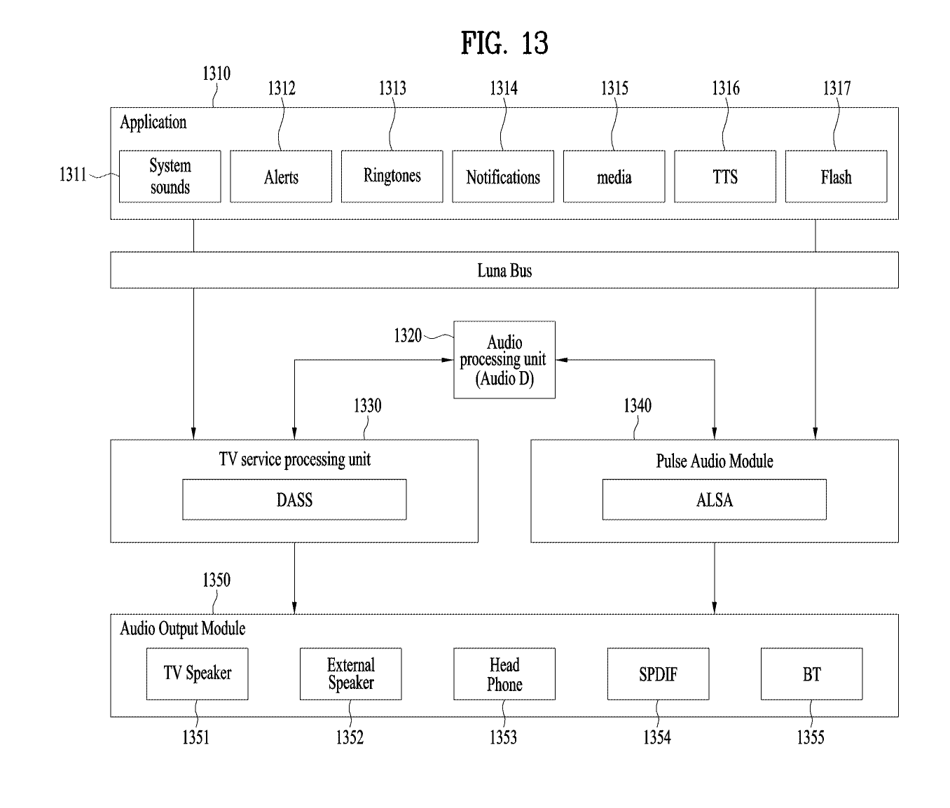

FIG. 13 is a block diagram for explaining a method of processing audio data in a digital device according to one embodiment of the present invention. A part of modules of a digital device shown in FIG. 13 can be added or changed with reference to FIGS. 1 to 12. In FIG. 13, a solid line arrow between configuration modules may indicate an inter-process call, i.e., a lunar service call, a notification such as registration and notification, or a data flow.

An application 1310 can be connected with various service processing configurations via a lunar-service bus and can be operated or controlled via a connected service processing configuration.

The application 1310 includes audio data and can include an application 1311 related to system sound, an application 1312 related to alert, an application 1313 related to ringtone, an application 1314 related to notification, an application 1315 related to media, an application 1316 related to TTS (text to speech), an application 1317 related to flash audio, and the like according to a type of the audio data. Yet, this is just an example only. More or less applications can be related to the application 1310. And, assume that functions necessary for operating the above applications are installed in the digital device.

As an example, the application 1311 related to the system sound may correspond to an application related to selection sound of a specific key mounted on a remote controller 610/620/630, selection sound of a specific application outputted on a display unit of a digital device, notification sound generated when a specific function of a digital device is executed, or the like.

The application 1312 related to alert, for example, may correspond to an application related to system sound of high priority.

The application 1313 related to ringtone, for example, may correspond to an application related to notification sound of a calling event received via a calling application.

The application 1314 related to notification, for example, may correspond to an application related to notification sound except the alert or notification sound for notifying occurrence of a specific event.

The application 1316 related to TTS (text to speech), for example, may correspond to an application related to audio data for outputting a guide message capable of being outputted via a display unit of a digital device as voice. The application related to TTS can be mainly used when a voice recognition function is activated.

The application related to flash audio, for example, may correspond to an application related to audio data streaming by Adobe flash.

A TV service processing unit 1330 or a pulse audio module 1340 can receive audio data from a specific application according to a user selection or occurrence of a specific event. For example, audio data processed by a decoder in a hardware manner can be received by the TV service processing unit 1330 and previously decoded audio data or PCM audio data, which is not necessary to be processed by a decoder in a hardware manner, can be received by the pulse audio module 1340. Whether audio data received from a specific application is received by the TV service processing unit 1330 or the pulse audio module 1340 can be controlled by an audio processing unit (AudioD) 1320. The TV service processing unit 1330 can include a DASS (DSP audio sink server) for processing audio data in a hardware manner (e.g., decoding). The pulse audio module 1340 can include an ALSA (advanced linux sound architecture) corresponding to an interface for outputting audio data.

If the TV service processing unit 1330 or the pulse audio module 1340 receives audio data from the application 1320, the TV service processing unit 1330 or the pulse audio module 1340 can informs the audio processing unit 1320 of a notification on the received audio data. The audio processing unit 1320 controls the TV service processing unit 1330 or the pulse audio module 1340 in a manner of applying a policy related to the audio data according to the notification and may be then able to control an output of the audio data.

If there exists audio data respectively corresponding to each of a plurality of contents, the audio data-related policy determines a type of audio data to be preferentially outputted based on priority per audio data type, controls an input volume level and/or an output volume level of specific audio data, and determines a port of an audio output unit 1350 for outputting the specific audio data. A memory (not depicted) of a digital device may store the audio data-related policy in advance. Yet, the audio processing unit 1320 can control the pulse audio module 1340 to immediately output audio data received from the system sound-related application 1311 via the audio output unit 1350 without applying the policy to promptly process the audio data.

The audio processing unit 1320 can adjust an input volume level and/or an output volume level of specific audio data. The audio processing unit 1320 can adjust the input volume level of the specific audio data by controlling an input source or may adjust the output volume level outputted from the audio output unit 1350 while the input volume level is maintained as it is.

The audio output unit 1350 can include not only a port connected with a TV speaker (e.g., internal speaker) but also a plurality of ports capable of outputting audio data. As an example, the audio output unit 1350 can include the port 1351 connected with the TV speaker, a port 1352 connected with an external speaker, a port 1353 connected with a headphone, an optical output port (SPDIF) 1354, a port 1355 connected with a Bluetooth speaker, etc. The audio output unit 1350 outputs audio data received from the TV service processing unit 1330 and/or the pulse audio module 1340.

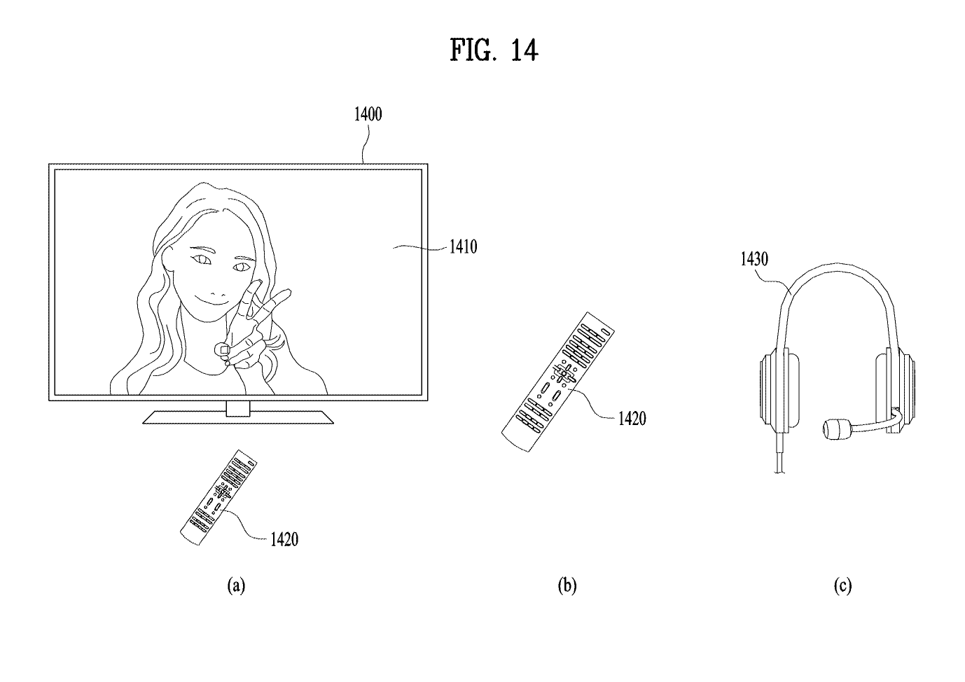

In the following, examples of a policy related to audio data, which is applied by the audio processing unit 1320, are explained according to a scenario with reference to FIGS. 14 to 21.

FIG. 14 is a diagram for explaining a method of activating a voice recognition function in a digital device according to one embodiment of the present invention. Yet, the method of activating the voice recognition function described in FIG. 14 is just an example only. Hence, the present invention may be non-limited by the example.

Referring to FIG. 14a, a user can activate a voice recognition function by selecting a predetermined area of a display unit 1410 of a display device 1400 or an icon of a specific application outputted on the display unit 1410 of the display device 1400 using a remote controller 1420.

Or, referring to FIG. 14b, a user can activate the voice recognition function by selecting a hot key corresponding to the voice recognition function that is mounted on the remote controller 1420. The user says a prescribed word or a sentence while pushing the hot key and releases the push of the hot key.

Or, referring to FIG. 14c, a user can activate the voice recognition function by pushing a specific button corresponding to a voice recognition function mounted on a headphone 1430 paired with the display device 1400. The user says a prescribed word or a sentence while pushing the specific button and releases the push of the specific button.

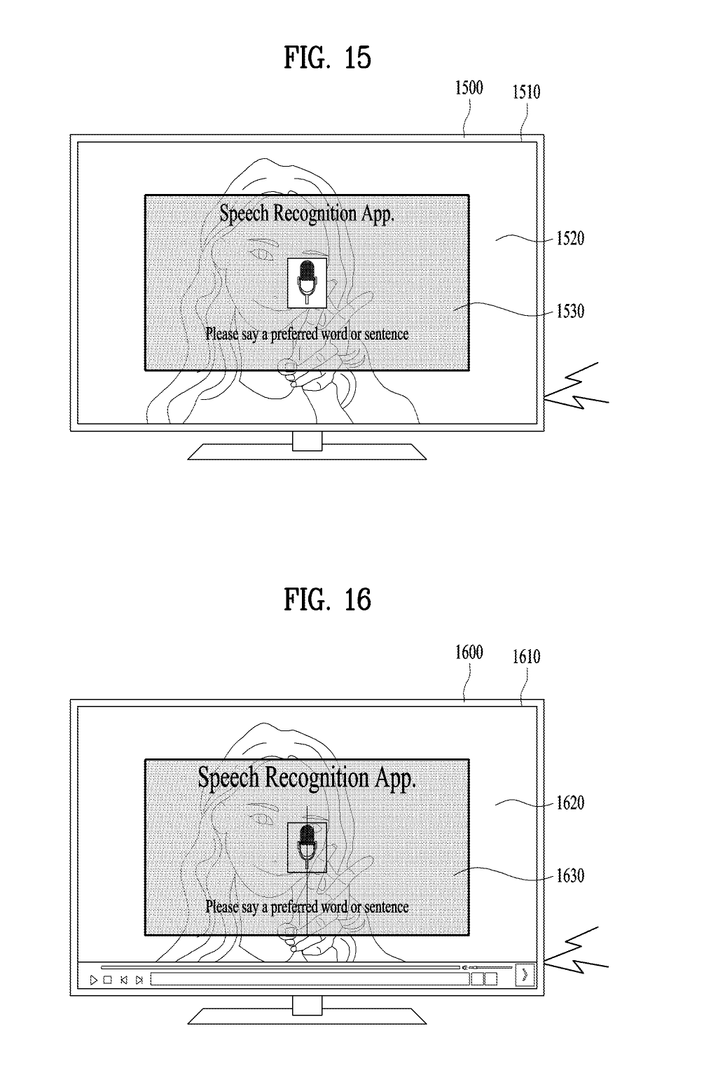

FIG. 15 is a diagram for explaining an example of an operation of an audio processing unit when a voice recognition function of a digital device is activated according to one embodiment of the present invention.

Referring to FIG. 15, a video data 1510 corresponding to a prescribed content is outputted on a display unit 1510 of a digital device 1500. And, a first audio data corresponding to the content is outputted via a TV speaker of the digital device 1500. As an example, assume that the content corresponds to a live broadcasting signal.

If a voice recognition function is activated by a user, a voice recognition application is executed and a first GUI corresponding to an execution screen of the voice recognition application can be outputted on the display unit 1510. If the voice recognition function is activated, a pulse audio module 1340 can receive second audio data, which indicates the start of voice recording for voice recognition, from the notification application 1315. And, the pulse audio module 1340 can inform the audio processing unit 1320 of the reception of the second audio data.

If audio data corresponding to a broadcast signal and audio data related to voice recognition coexist, the audio processing unit 1320 can adjust output of the first and the second audio data based on a policy related to the audio data. For example, if priority of the audio data related to the voice recognition function is higher than priority of the audio data corresponding to the broadcast signal, the audio processing unit 1320 controls the pulse audio module 1340 to set an output volume level of the second audio data to a volume level set to the TV speaker and controls the TV service processing unit 1330 to reduce an input volume level of the first audio data to a predetermined volume level based on the volume level set to the TV speaker. Depending on an embodiment, when the first audio data is also processed by the pulse audio module 1340, the audio processing unit 1330 can adjust the pulse audio module 1340 to adjust the output of the first audio data. In a state that the output volume level of the first audio data and the output volume level of the second audio data are adjusted, the first audio data and the second audio data are mixed by a mixer (not depicted) and can be outputted at the same time via the TV speaker.

Hence, the output volume level of the first audio and the output volume level of the second audio data outputted via the TV speaker may be different from each other. In particular, when the voice recognition function is activated, if the output volume of the second audio data, which indicates the start of the voice recording for the voice recognition, is set to be higher than the output volume of the first audio data corresponding to the broadcast signal, it is able to make a user recognize that the voice recognition function is activated and it is necessary for the user to start to say a prescribed word or a sentence.

If the second audio data is outputted via the TV speaker, the user says a preferred word or sentence. If the speech of the user is completed, the pulse audio module 1340 can receive third audio data, which indicates the completion of the voice recording for the voice recognition, from the notification application 1315. The audio processing unit 1320 can also process the third audio data in a manner of being similar to the second audio data in relation to the first audio data.

The audio processing unit 1320 can control the output volume level of the first audio data to be lower than the output volume level of the first audio data while a user is saying a preferred word or sentence.

Depending on an embodiment, if the voice recognition function is activated, the output level of the first audio data corresponding to the broadcast signal may correspond to 0. For example, the audio processing unit 1320 can adjust an input volume level to 0 by controlling an input source corresponding to the first audio data.

And, depending on an embodiment, if the pulse audio module 1340 receives specific audio data from the TTS application 1316 in a state that the voice recognition function is activated, the audio processing unit 1320 adjusts the input volume level of the first audio data to 0 and can control the pulse audio module 1340 to output specific audio data related to the TTS application only via the TV speaker. Hence, the TV speaker can output the audio data related to the TTS application only without outputting the first audio data. If the pulse audio module 1340 completely receives audio data from the TTS application 1316, it may be able to control the pulse audio module 1340 to make the first audio data to be outputted again with the volume level set to the TV speaker.

FIG. 16 is a diagram for explaining a different example of an operation of an audio processing unit when a voice recognition function of a digital device is activated according to one embodiment of the present invention. Explanation on contents overlapped with the contents of FIG. 15 is omitted. In the following, a difference between the contents of FIG. 15 and the contents of FIG. 16 is mainly explained.

Referring to FIG. 16, a video data 1610 corresponding to a prescribed content is outputted on a display unit 1610 of a digital device 1600. And, a first audio data corresponding to the content is outputted via a TV speaker of the digital device 1600. As an example, assume that the content corresponds to such a file capable of being stopped playing or paused as an mp3 file, a video file, and the like.

If a voice recognition function is activated by a user, a voice recognition application is executed and a first GUI 1630 corresponding to an execution screen of the voice recognition application can be outputted on the display unit 1610.

If the voice recognition function is activated by the user, playback of the content can be paused while voice recording for voice recognition is performed. Hence, the audio processing unit 1330 controls the pulse audio module 1340 to output the second audio data and the third audio data with a volume level set to the TV speaker only. The TV speaker can output the second audio data and the third audio data only without outputting the first audio data.

FIG. 17 is a diagram for explaining a further different example of an operation of an audio processing unit when a voice recognition function of a digital device is activated according to one embodiment of the present invention. Explanation on contents overlapped with the contents mentioned earlier in FIGS. 15 and 16 is omitted. In the following, a difference is mainly explained.

Referring to FIG. 17, a video data 1710 corresponding to a prescribed content is outputted on a display unit 1710 of a digital device 1700. And, a first audio data corresponding to the content is outputted via a headphone 1740 of the digital device 1700. As an example, assume that the content corresponds to a live broadcast signal.

If a voice recognition function is activated by a user, a voice recognition application is executed and a first GUI 1730 corresponding to an execution screen of the voice recognition application can be outputted on the display unit 1510.

If the first audio data is outputted via the headphone 1740, the first audio data and second audio data are mixed by a mixer (not depicted) and can be outputted at the same time via the headphone 1740. And, the first audio data and third audio data are mixed by the mixer (not depicted) and can be outputted at the same time via the headphone 1740.

Depending on an embodiment, when the content corresponds to a file capable of being stopped playing or paused instead of a live broadcast signal, if the voice recognition function is activated by the user, playback of the content is paused. And, the audio processing unit 1330 can control the pulse audio module 1340 to output the second audio data and the third audio data only with a volume level set to the headphone 1740.

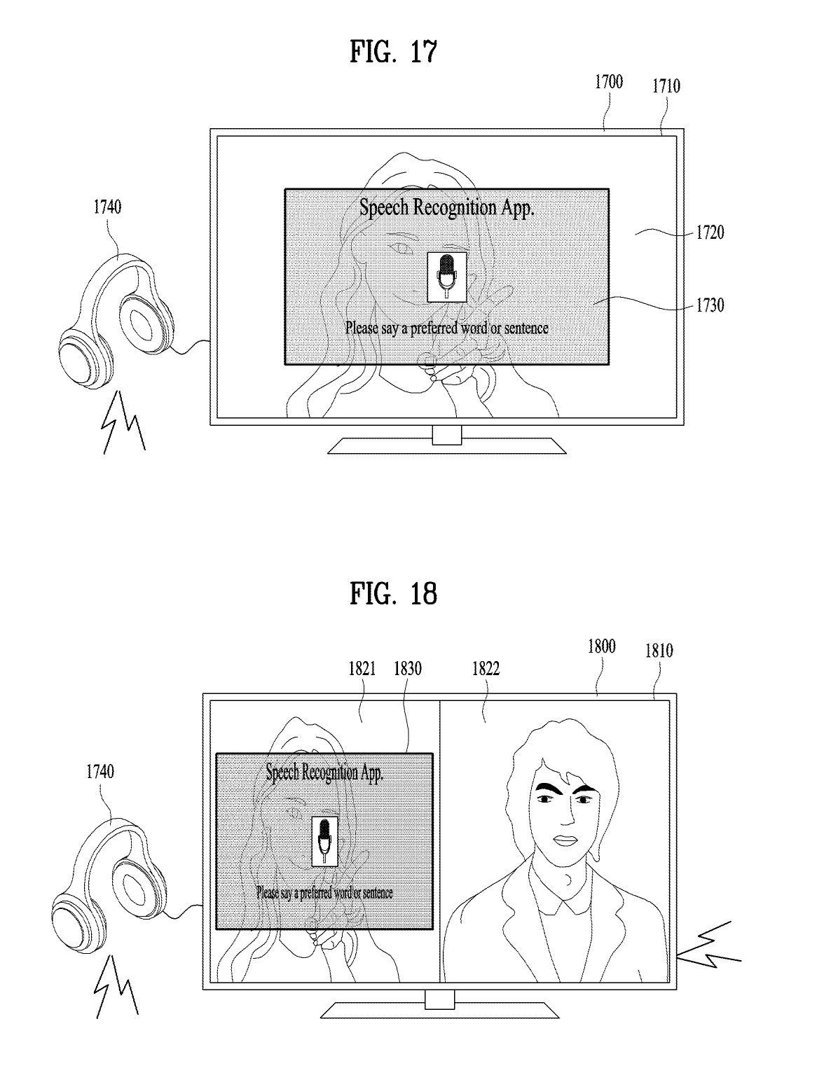

FIG. 18 is a diagram for explaining a further different example of an operation of an audio processing unit when a voice recognition function of a digital device is activated according to one embodiment of the present invention.

A display unit 1810 of a digital device 1800 can respectively output video data corresponding to two or more contents via virtual screen division. For example, a video data 1821 corresponding to first content is outputted in a first area of the display unit 1810 and a video data 1822 corresponding to second content can be outputted in a second area of the display unit 1810. As an example, assume that the first content corresponds to a live broadcast signal and the second content corresponds to a video/audio data streaming by Adobe flash. And, assume that the audio data corresponding to the first content is outputted via a headphone 1840 and the audio data corresponding o the second content is outputted via a TV speaker.

If a user pushes a specific button mounted on the headphone which is related to a voice recognition function to activate the voice recognition function, a voice recognition application is executed and a first GUI 1830 corresponding to an execution screen of the voice recognition application can be outputted in a first area of the display unit 1810 on which the first video data is outputted. FIG. 18 shows a case that the digital device 1800 is used by a plurality of users. In this case, in order to meet intentions of all users, it is able to make a user wearing the headphone 1840 activate the voice recognition function only.

The audio processing unit 1320 can make the second audio data to be outputted as it is with a volume level set to the TV speaker without adjusting the output of the second audio data. Meanwhile, the audio processing unit 1320 controls the TV service processing unit 1330 to reduce an input volume level of the first audio data to a predetermined level based on the volume level set to the TV speaker. The audio processing unit can control the pulse audio module 1340 to output third audio data, which indicates the start of voice recording for voice recognition received from the notification application 1315, with a volume level set to a headphone 1840. In particular, the second audio data and the third audio data are mixed by a mixer in a state that the output volume level of the second audio data and the output volume level of the third audio data are adjusted and can be outputted at the same time via the headphone 1840.

If the audio processing unit 1320 receives fourth audio data indicating the completion of the voice recording for voice recognition from the notification application 1315, the audio processing unit 1320 can also process the fourth audio data in a manner of being similar to the third audio data in relation to the first audio data.

Depending on an embodiment, when the first content corresponds to a file capable of being stopped playing or paused instead of a live broadcast signal, if the voice recognition function is activated by the user, playback of the content is paused. And, the audio processing unit 1330 can control the pulse audio module 1340 to output the third audio data and the fourth audio data only with a volume level set to the headphone 1840.

FIG. 19 is a diagram for explaining an example of an operation of an audio processing unit when an event related to a ringtone application occurs in a digital device according to one embodiment of the present invention.

Referring to FIG. 19, a video data 1920 corresponding to a prescribed content is outputted on a display unit 1910 of a digital device 1900. And, a first audio data corresponding to the content is outputted via a TV speaker of the digital device 1900. As an example, assume that the content corresponds to a live broadcast signal.

For example, if a calling event occurs via a calling application, the calling application is executed and a second GUI 1930 corresponding to an execution screen of the calling application can be outputted on the display unit 1910. The second GUI 1930 can include a message for notifying the occurrence of the calling event and menus for accepting or rejecting a call. And, the pulse audio module 1340 can receive second audio data corresponding to a ringtone received from a ringtone application 1313. And, the pulse audio module 1340 can inform the audio processing unit 1320 of the reception of the second audio data.

If audio data corresponding to a broadcast signal and audio data related to the ringtone application coexist, the audio processing unit 1320 can adjust output of the first and the second audio data based on a policy related to the audio data. For example, if priority of the audio data related to the ringtone application is higher than priority of the audio data corresponding to the broadcast signal, the audio processing unit 1320 controls the pulse audio module 1340 to set an output volume level of the second audio data to a volume level set to the TV speaker and controls the TV service processing unit 1330 to reduce an input volume level of the first audio data to a predetermined volume level based on the volume level set to the TV speaker. Or, if the priority of the audio data corresponding to the broadcast signal and the priority of the audio data related to the ringtone application identical to each other, it may be able to make the first and the second audio data to be mixed and to be outputted with the volume level set to the TV speaker.

Depending on an embodiment, if a user selects a calling menu 1931 from the second GUI 1930, the audio processing unit 1320 can adjust an input volume level to 0 in a manner of controlling an input source corresponding to the first audio data.

And, depending on an embodiment, when the content corresponds to a file capable of being stopped playing or paused instead of a live broadcast signal, if the audio data related to the ringtone application occurs, playback of the content can be paused.

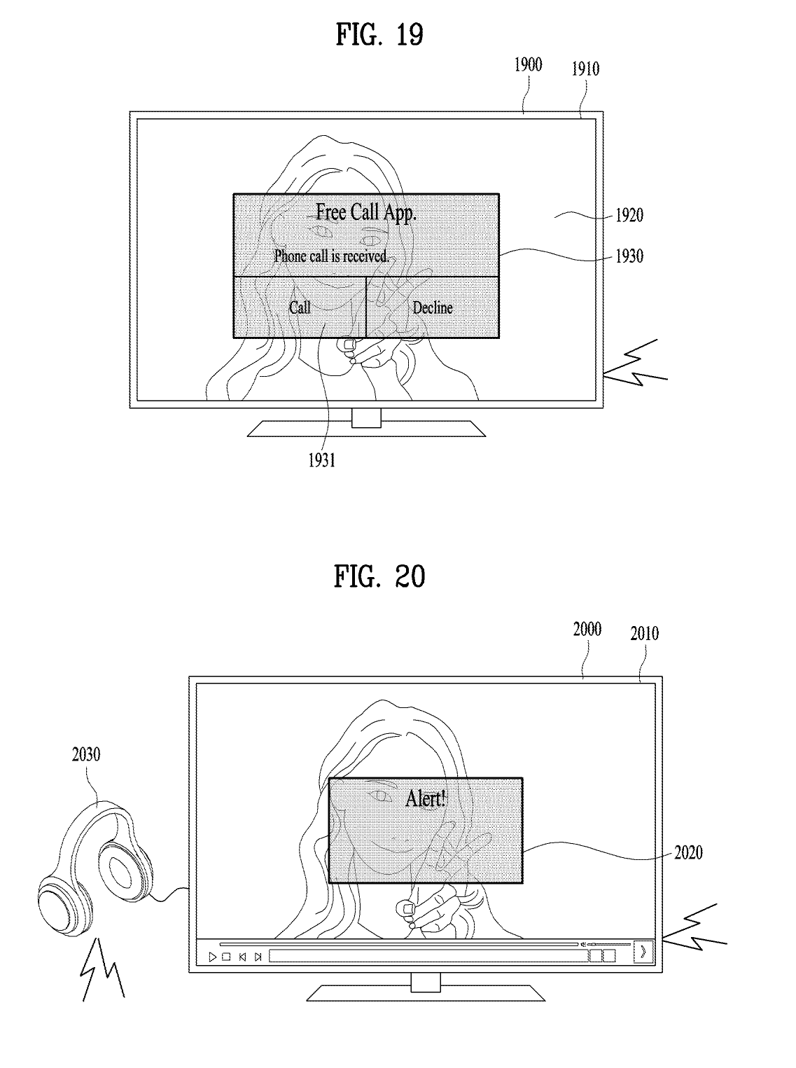

FIG. 20 is a diagram for explaining an example of an operation of an audio processing unit when an event related to an alert application occurs in a digital device according to one embodiment of the present invention.

Referring to FIG. 20, a prescribed content is in a state of being stopped playing or paused in a display unit 2010 of a digital device 2000 or a screen irrelevant to a content including audio data is displayed. A headphone 2030 is connected with a specific port included in an audio output unit 1350 of the digital device 2000. Currently, assume that no audio data is outputted via the headphone 2030 or a TV speaker.

For example, if a specific event related to an alert application occurs, the alert application is executed and a third GUI 2020 corresponding to an execution screen of the alert application can be outputted on the display unit 2010. The third GUI 2020 can include a message for explaining contents of the specific event. And, the pulse audio module 1340 can receive first audio data corresponding to alert sound received from the alert application 1312. And, the pulse audio module 1340 can inform the audio processing unit 1320 of the reception of the first audio data.

If specific content including audio data is currently not played while the headphone 2030 is connected with a port of the audio output unit 1350, the audio processing unit 1320 can control the pulse audio module 1340 to output the second audio data to be outputted via the TV speaker and the headphone 2030 at the same time based on a policy related to the alert application. In this case, the second audio data is outputted via the TV speaker according to a volume level set to the TV speaker and the second audio data can be outputted via the headphone 2030 according to a volume level set to the headphone 2030.

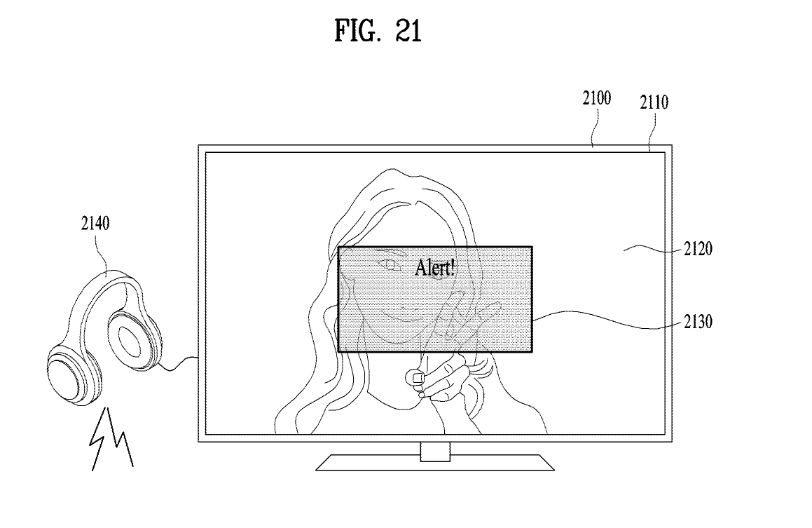

FIG. 21 is a diagram for explaining a different example of an operation of an audio processing unit when an event related to an alert application occurs in a digital device according to one embodiment of the present invention. Explanation on contents overlapped with the contents mentioned earlier in FIG. 20 is omitted. In the following, a difference is mainly explained.

Referring to FIG. 21, video data corresponding to prescribed content is outputted on a display unit 2110 of a digital device 2100. And, first audio data corresponding to the content is outputted via a headphone 2140 connected with the digital device 2100.

For example, if a specific event related to an alert application occurs, the alert application is executed and a third GUI 2130 corresponding to an execution screen of the alert application can be outputted on the display unit 2110. The third GUI 2020 can include a message for explaining contents of the specific event. And, the pulse audio module 1340 can receive second audio data corresponding to alert sound received from the alert application 1312. And, the pulse audio module 1340 can inform the audio processing unit 1320 of the reception of the second audio data.

If the headphone 2140 is connected with a port of the audio output unit 1350 and first audio data corresponding to currently playing content is outputted via the headphone 2140, the audio processing unit 1320 can control the pulse audio module 1340 to output the second audio data to be outputted via the headphone 2140 based on a policy related to the alert application. In this case, the second audio data is outputted via the headphone 2140 only and may not be outputted via the TV speaker.

If there exists audio data related to the alert application, the audio processing unit 1320 can adjust outputs of the first and the second audio data based on a policy related to the alert application. For example, the audio processing unit 1320 can adjust an output volume level of the second audio data to be higher than an output volume level of the first audio data or adjust the output volume level of the second audio data to be equal to the output volume level of the first audio data. Depending on an embodiment, if the contents correspond to a file capable of being stopped playing or paused, playback of the content can be paused. And, depending on an embodiment, it may be able to make an output volume level of the second audio data no to be higher than a volume level set to the headphone 2140 to prevent a user from being surprised.

As mentioned in the foregoing description, according to the embodiments of the present invention, it is able to control audio data in accordance with an intention of a user when the audio data corresponding to a plurality of contents are outputted at the same time.

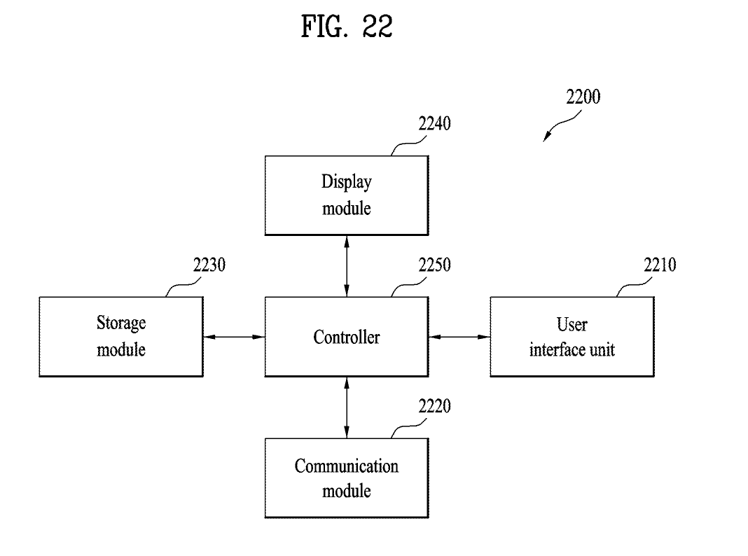

FIG. 22 is a block diagram for configuration modules of a digital device according to a different embodiment of the present invention. A part of modules of a digital device shown in FIG. 11 can be added or changed with reference to FIGS. 1 to 12. The scope of the present invention is determined not by the elements written on FIG. 22 but by items written in the claims in principle. As shown in FIG. 22, a digital device 2200 according to a different embodiment of the present invention includes a user interface unit 2210, a communication module 2220, a storage module 2230, a display module 2240 and a controller 2250.

The user interface unit 2210 can receive text data input or image data input from a user. The user interface unit 2210 can generate a window and a graphical user interface for receiving the text data input or the image data input from the user. The user interface unit 2210 can receive a specific signal via a touch panel connected with the display module 2240 of the digital device 2200 and receive a specific signal using an IR (infrared Ray) signal received from a sensor module (not depicted).

The communication module 2220 can transceive data with an external server, an external device or the like. A communication network including wired/wireless network supporting various communication specifications or protocols is commonly referred to as the communication module 2220. The wired/wireless network includes both a currently supported communication network and a communication network to be supported in the future based on a specification. The wired/wireless network can support one or more communication protocols for the communication network. For example, the wired/wireless network can be configured by a network for such a wired connection as USB, CVBS, Component, S-video (analog), DVI, HDMI, RGB, and D-SUB and a communication specification/protocol for the network and a network for such a wireless communication as Bluetooth, RFID, IrDA, UWB, ZigBee, DLNA, Wi-Fi, Wibro, Wimax, HSDPA, LTE/LTE-A, Wi-Fi direct and a communication specification/protocol for the network.

The storage module 2230 can store web application information and deep linking data. The storage module can store the deep linking data supported by each web application in a manner of mapping the deep linking data to a web application name.

The display module 2240 can display at least one or more deep linking data received by a digital device on a screen in a manner of processing the deep linking data according to one embodiment of the present invention. The at least one or more deep linking data can be extracted from the deep linking data stored in the storage module 2230.

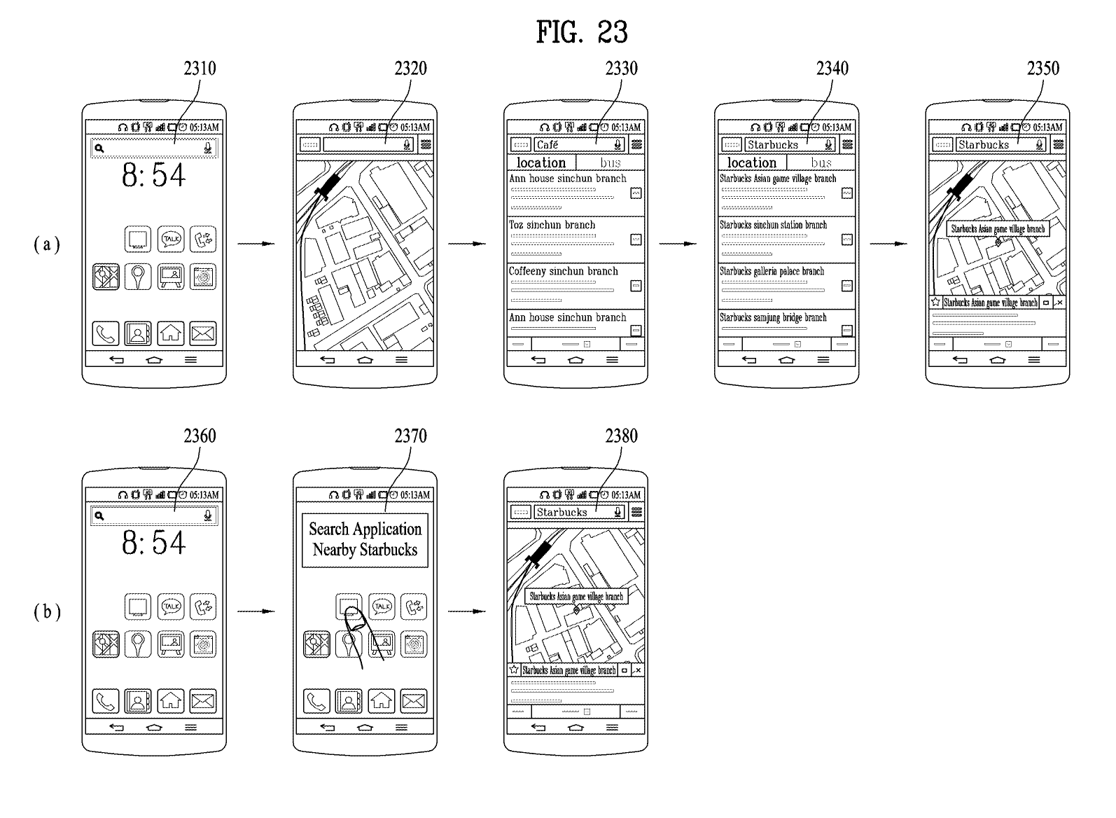

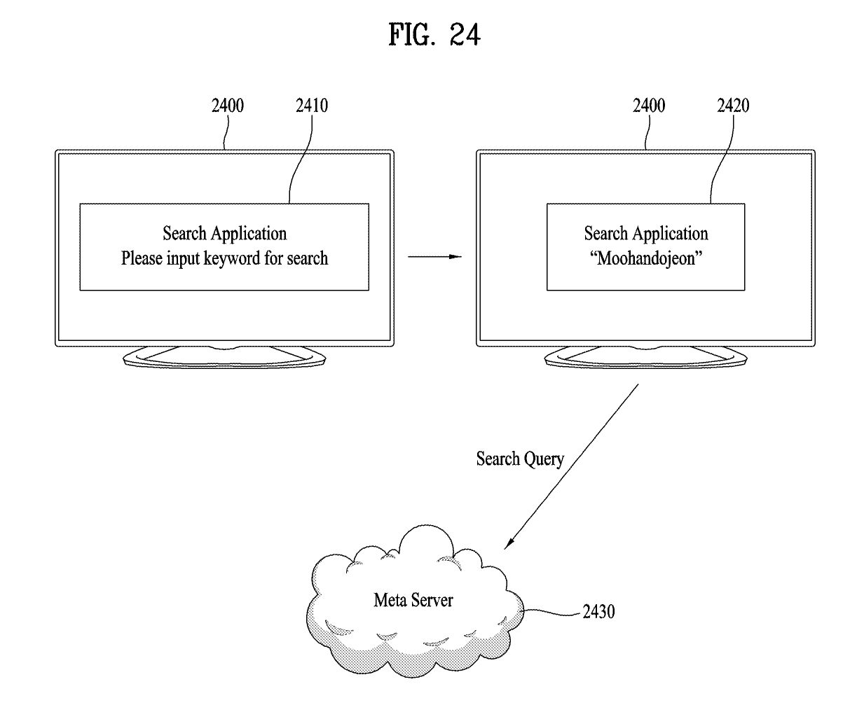

The controller 2250 performs a function of generally managing functions of at least one or more modules shown in FIG. 22 including the user interface unit 2210, the communication module 2220, the storage module 2230, and the display module 2240. In relation to this, it shall be explained in more detail with reference to FIGS. 23 to 31 in the following.

FIG. 23 is a diagram for explaining a deep linking function supported by a digital device according to one embodiment of the present invention.

A controller of the digital device according to one embodiment of the present invention receives a text input, queries web application information and content information matched with the text to a Meta server, receives a plurality of web application information and content information matched with the text from the Meta server, extracts deep linking data matched with a plurality of the received web application information from the storage module, and displays a list of the extracted deep linking data, which are arranged according to a category, on a screen. If a signal for selecting at least one or more deep linking data from the list is received, the controller can control content of a web application corresponding to the selected deep linking data to be displayed on the screen.

The deep linking data corresponds to data provided to support a deep linking function. The deep linking function may correspond to a function for enabling a user to directly access content located at a low level of an application including a web application.

For example, as shown in FIG. 23a, according to a controller of a legacy digital device, if a user executes a map application 2320 providing location information in a home screen 2310 and searches for a specific location 2330 in the map application 2320, the controller provides a search list 2340 related to the specific location to the user. If the user selects a specific item from the search list 2340, the controller can control a map image 2350 on which a corresponding location is displayed to be displayed on a screen.

On the contrary, as shown in FIG. 23b, according to a controller of a digital device according to one embodiment of the present invention, if a user inputs a text 2370 related to a specific location to a search application in a home screen 2360, the controller determines it as the text inputted by the user is used for searching for a specific location. Hence, the controller searches for a current position of the digital device and can control a map image 2380 on which a closest location is displayed to be immediately displayed on a screen.

Hence, it is not necessary for a user using a digital device configured to provide a deep linking function to perform a procedure of entering a low level of an application, thereby increasing user convenience in using an application.

FIG. 24 is a diagram for explaining an example of receiving a text input using a search application in a digital device according to one embodiment of the present invention.

As shown in FIG. 24, if a user executes a search application, a controller of a digital device according to one embodiment of the present invention can control a GUI 2410 for receiving a text input to be displayed on a screen. If a user inputs at least one or more texts 2420, the controller can control to query web application information and content information matched with the text to a Meta server 2430.

The Meta server 2430 stores at least one or more web application information and content information provided by the web application in a manner of mapping the informations with each other. The web application information includes an application ID (AppID) and the AppID can be configured by a URL (universal resource locator) address.

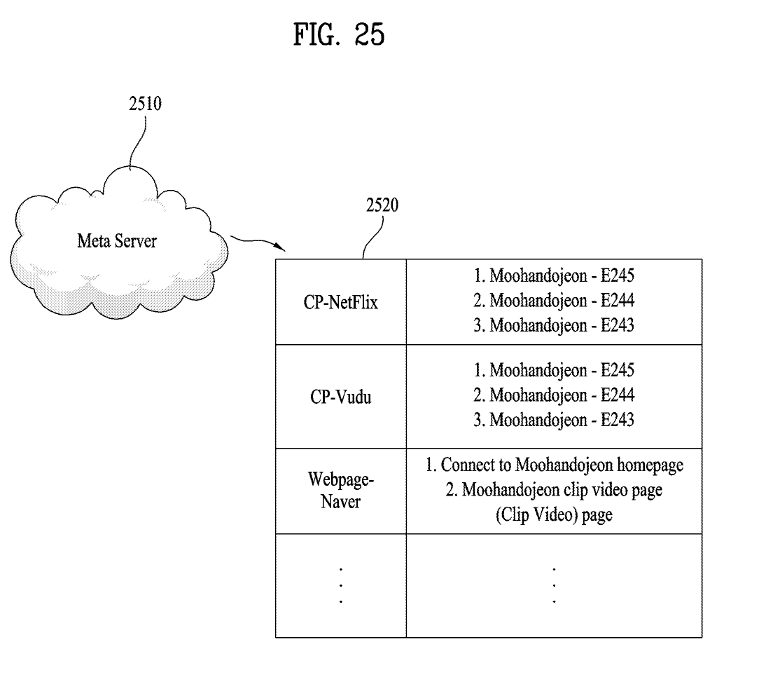

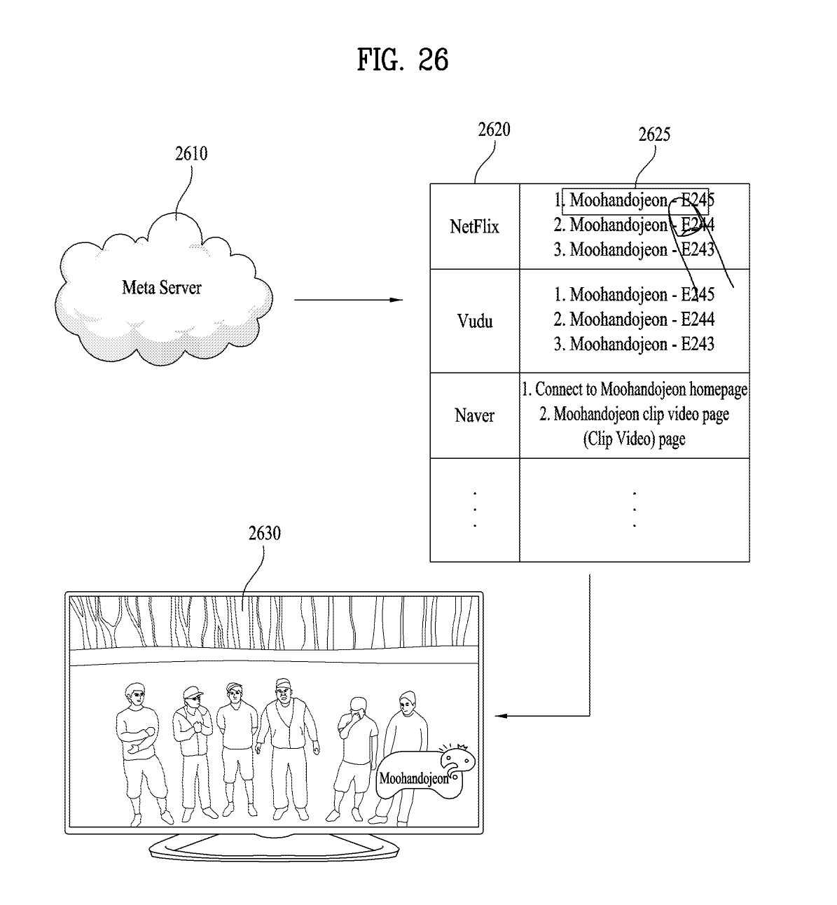

FIG. 25 is a diagram for explaining an example for a digital device to receive web application information and content information from a Meta server according to one embodiment of the present invention.

As shown in FIG. 25, a controller of a digital device according to one embodiment of the present invention receives a text input from a user using a search application and can control to query web application information and content information matched with the text to a Meta server 2510. And, the Meta server 2510 receives at least one or more web application information included in the digital device and may be able to extract content information matched with the text among all content information included in the at least one or more received web application information. And, the Meta server 2510 can transmit a list 2520 of which the at least one or more web application information and content information matched with the text among contents included in the at least one or more web applications are mapped with each other to the digital device.

FIG. 26 is a diagram for explaining an example for a digital device to execute a deep linking function using a list received from a Meta server according to one embodiment of the present invention.

As shown in FIG. 26, if a list of which at least one or more web application information matched with a text inputted by a user and content information of the at least one or more web applications are mapped with each other is received, a controller of a digital device according to one embodiment of the present invention accesses a storage module of the digital device, extracts deep linking data matched with the at least one or more received web application information, and control a list 2620 of the extracted deep linking data, which are arranged according to a web application category, to be displayed on a screen. If a signal for selecting at least one or more deep linking data 2625 from the list 2620 is received, the controller can control content 2630 of a web application corresponding to the selected deep linking data 2625 to be displayed on a screen.

If a digital device is designed according to the embodiments of FIGS. 24 to 26, a user can easily and quickly receive a deep linking service from the digital device in which a web application is installed.

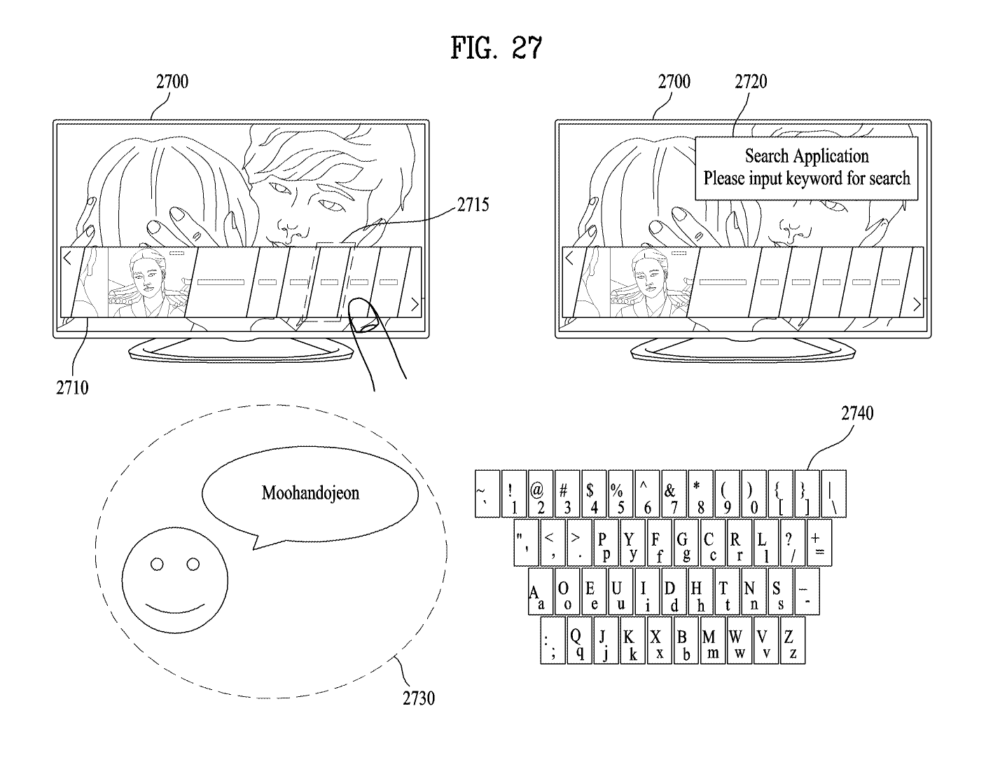

FIG. 27 is a diagram for explaining an example of using a search application in a digital device according to one embodiment of the present invention.

As shown in FIG. 27, if a frequent or a specific function key signal is received on a home screen, a controller of a digital device 2700 according to one embodiment of the present invention can control a bookmark web application list 2710 to be displayed on a screen. And, if the controller receives a signal for a user to select a search application icon 2715 in the list 2710, the controller can control a GUI 2720 for enabling the user to receive a deep linking service via the search application to be displayed on the screen. And, the user can input a text to the GUI 2720 using a voice recognition function 2730 or an external input means such as a keyboard 2740 or the like.

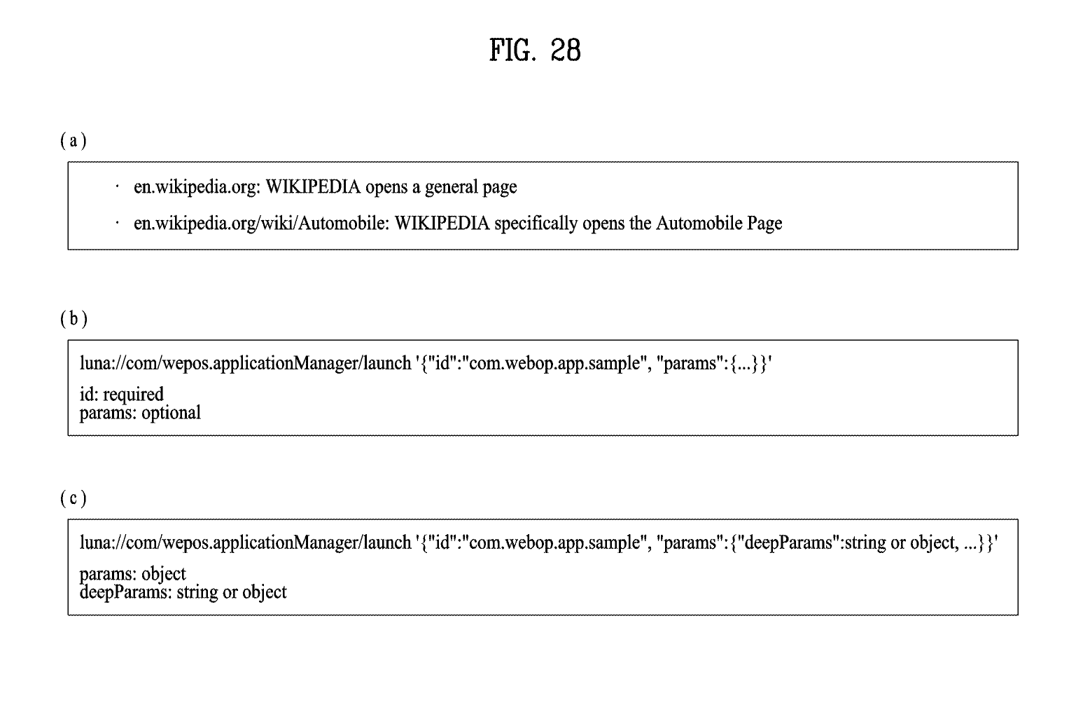

FIG. 28 is a diagram for explaining an example of processing a deep linking data in a digital device according to one embodiment of the present invention.

A controller of the digital device according to one embodiment of the present invention receives a text input, queries web application information and content information matched with the text to a Meta server, receives a plurality of web application information and content information matched with the text from the Meta server, extracts deep linking data matched with a plurality of the received web application information from a storage module, and displays a list of the extracted deep linking data, which are arranged according to a category, on a screen. If a signal for selecting at least one or more deep linking data from the list is received, the controller can control content of a web application corresponding to the selected deep linking data to be displayed on the screen.

The Meta server stores at least one or more web application information and content information provided by the web application in a manner of mapping the informations with each other. The web application information includes an application ID (AppID) and the AppID can be configured by a URL (universal resource locator) address.

For example, as shown in FIG. 28a, en.wikipedia.org corresponds to a URL address for outputting a main page of WIKIPEDIA and en.wikipedia.org/wiki/Automobile may correspond to a URL address for outputting Automobile page among a plurality of pages of WIKIPEDIA. In particular, the en.wikipedia.org/wiki/Automobile may correspond to a URL address including information corresponding to a deep linking data of a web application.

And, if a deep linking data is extracted from the storage module, the controller of the digital device according to one embodiment of the present invention generates a parameter corresponding to the deep linking information and may be able to search for content included in a specific web application using the web application information and the generated parameter. The parameter can be generated in a different language depending on each of a plurality of web applications stored in the Meta server.

For example, as shown in FIGS. 28b and 28c, when an application manager loads a web application and executes the web application, the controller of the digital device according to one embodiment of the present invention can deliver a signal for requesting execution of a specific web application to the application manager. The signal can include an ID of the web application (application ID) and a parameter. Hence, the application manager can control specific content of the specific web application to be immediately outputted on the screen using the web application ID and the parameter included in the signal.

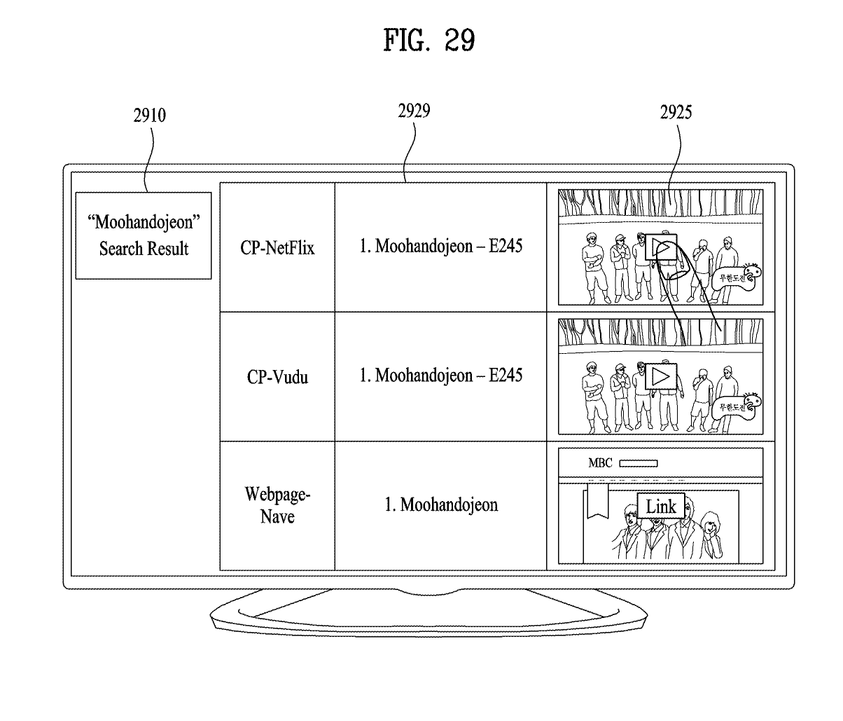

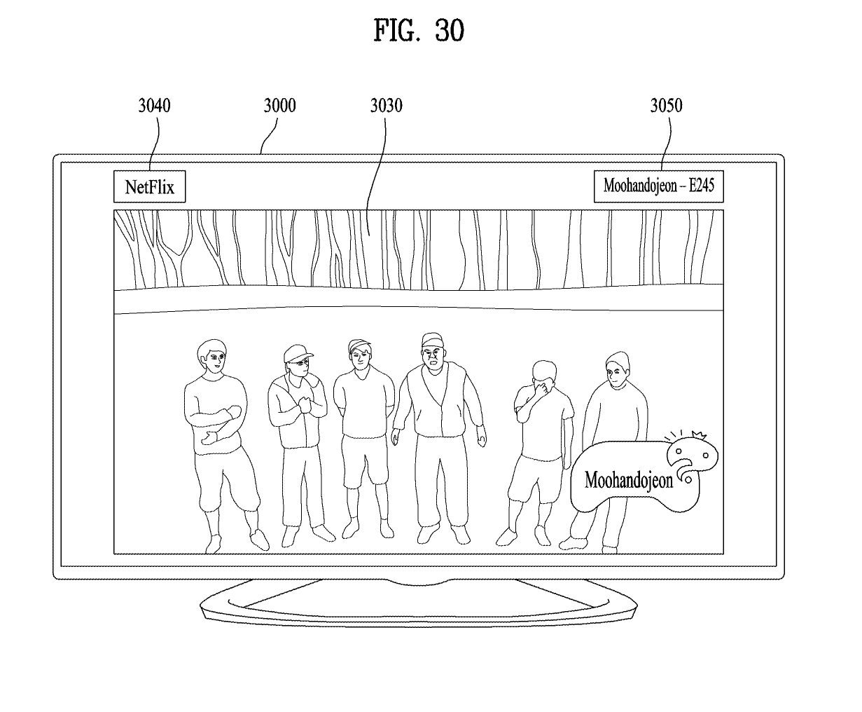

FIGS. 29 and 30 are diagrams for explaining an example for a digital device to generate a search list using a snapshot image according to one embodiment of the present invention.

A controller of the digital device 2900 according to one embodiment of the present invention receives a text input, queries web application information and content information matched with the text to a Meta server, receives a plurality of web application information and content information matched with the text from the Meta server, extracts deep linking data matched with a plurality of the received web application information from a storage module, and displays a list 2920 of the extracted deep linking data, which are arranged according to a category, on a screen. If a signal for selecting at least one or more deep linking data from the list 2920 is received, the controller can control content of a web application corresponding to the selected deep linking data to be displayed on the screen.

And, the list 2920 can include snapshot images of contents provided by each web application matched with the text. If a user selects at least one or more snapshot images from the list, the controller can control contents corresponding to the selected snapshot images to be displayed on the screen.

For example, as shown in FIG. 29, if a user inputs ‘Moohandojeon’ using a search application, the controller can control text information 2910 inputted by the user, web application information matched with the text information and a search list 2920 including content information to be displayed on the screen. And, the search list 2920 can include snapshot images of contents provided by each web application matched with the text.

And, as shown in FIG. 30, if the controller receives a signal of a user selecting a specific snapshot image included in the search list 2920, the controller can control content 3030 corresponding to the selected snapshot image 2925 to be displayed on the screen. In this case, the controller can control web application information 3040 providing the content and additional information 3050 of the content to be displayed on the screen together with the content 3030.

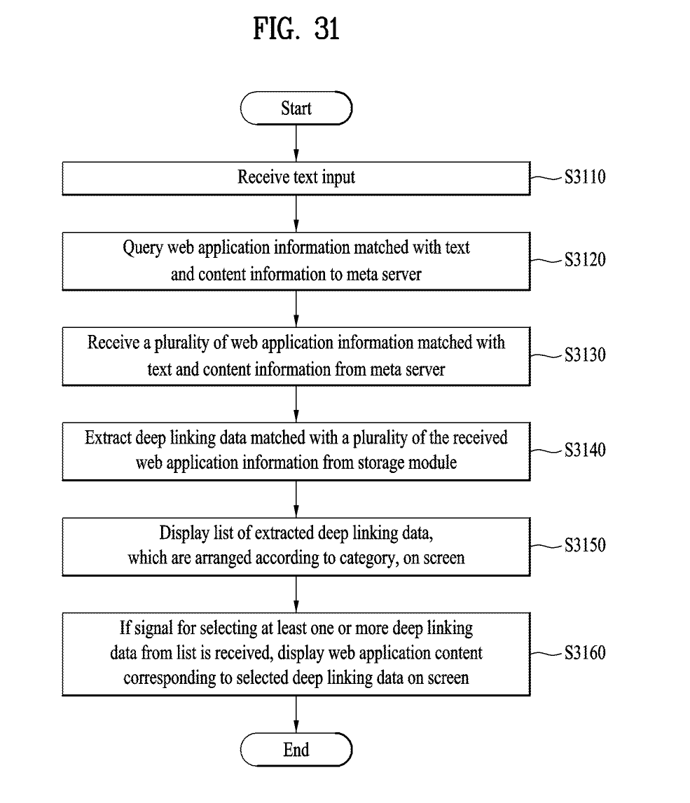

FIG. 31 is a flowchart for a method of controlling a digital device according to one embodiment of the present invention.

As shown in FIG. 31, a method of controlling a digital device according to one embodiment of the present invention can be implemented in a manner of including the steps of receiving a text input (S3110), querying web application information matched with the text and content information to a Meta server (S3120), receiving a plurality of web application information matched with the text and content information from the Meta server (S3130), extracting deep linking data matched with a plurality of the received web application information from a storage module (S3140), displaying a list of the extracted deep linking data, which are arranged according to a category, on a screen (S3150), if a signal for selecting at least one or more deep linking data from the list is received, displaying web application content corresponding to the selected deep linking data on the screen (S3160). Since detail explanation on each step is identical to what is mentioned above, duplicated explanation is omitted.

### MODE FOR INVENTION

A digital device and a method of processing contents thereof disclosed in the present specification may be non-limited to the aforementioned configurations and method of embodiments. The embodiments may be composed in a manner that a whole or a part of the each of the embodiments is selectively combined to achieve various modifications.

Meanwhile, a method of operating a digital device disclosed in the present specification can be implemented with a code readable by a processor in a recording media in which a program is recorded. The recording media readable by the processor includes recording devices of all types in which data readable by the processor is stored. The examples of the recording media readable by the processor may include a ROM, a RAM, a CD-ROM, a magnetic tape, a floppy disc, an optical data storing device and the like. And, implementing in a form of a carrier wave (e.g., transmission via the internet) is also included. The recording media readable by the processor are distributed to the computer systems connected by a network and codes readable by the processor can be stored and executed in a manner of being distributed.

While the present specification has been described and illustrated herein with reference to the attached drawings thereof, the present invention may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

### INDUSTRIAL APPLICABILITY

The present invention relates to a digital device and a method of controlling therefor. The digital device and the method of controlling therefor are industrially usable.

What is claimed is:

1. A digital device, comprising:
a pulse audio module configured to receive audio data of a first type and audio data of a second type different from the first type from an application;
an audio processing unit; and
an audio output unit,
wherein the pulse audio module informs the audio processing unit of reception of the first and the second type audio data, wherein the audio processing unit controls the pulse audio module to adjust outputs of the first and the second type audio data based on a policy related to the first and the second type audio data, and wherein the audio output unit outputs at least one of the first type audio data and the second type audio data based on a result of the adjustment of the pulse audio module.

2. The digital device of claim 1, wherein the policy relates to a port of the audio output unit to be used for outputting each of volume levels of the first and the second type audio data based on priority according to an audio data type and each of the first and the second type audio data.

3. The digital device of claim 1, wherein if the first type audio data corresponds to a TTS (text to speech) type among the first and the second type audio data, the audio output unit outputs audio data corresponding to the first type audio data only among the first and the second type audio data.

4. The digital device of claim 3, wherein if reception of the first type audio data is completed, the pulse audio module informs the audio processing unit of the completion of the reception of the first type audio data and wherein the audio output unit outputs the second type audio data.

5. The digital device of claim 1, wherein if the first type audio data relates to a voice recognition function, the audio processing unit controls the pulse audio module to adjust an output of the second type audio data based on a volume level set to the audio output unit.

6. The digital device of claim 1, wherein the first and the second type audio data correspond to a decoded audio data or a PCM audio data.

7. The digital device of claim 1, wherein the audio output unit comprises a TV speaker and a headset and wherein if one of the first and the second type audio data corresponds to alert, the audio data corresponding to the alert is outputted via the TV speaker and the headset, respectively.

8. The digital device of claim 1, wherein the audio processing unit adjusts outputs of the first and the second type audio data based on the policy or adjusts a volume level set to the audio output unit based on the policy.

9. A digital device, comprising:
a pulse audio module configured to receive audio data of a first type from an application;
a TV service processing unit configured to receive audio data of a second type from an application;
an audio processing unit; and
an audio output unit,
wherein the pulse audio module informs the audio processing unit of reception of the first type audio data, wherein the TV service processing unit informs the audio processing unit of reception of the second type audio data, wherein the audio processing unit respectively controls the pulse audio module and the TV service module to adjust outputs of the first and the second type audio data based on a policy related to the first and the second type audio data, and wherein the audio output unit outputs at least one of the first type audio data and the second type audio data based on a result of the adjustment of each of the pulse audio module and the TV service processing unit.

10. The digital device of claim 9, wherein the TV service processing unit comprises a hardware decoder and wherein the second type audio data is decoded using the decoder.

11. The digital device of claim 9, wherein if the first type audio data relates to a voice recognition function, the audio processing unit controls the pulse audio module to reduce a volume of the second type audio data until a predetermined volume based on a volume level set to the audio output unit.

12. The digital device of claim 11, wherein a volume level of the first type audio data outputted via the audio output unit and a volume level of the second type audio data outputted via the audio output unit are different from each other.

13. A method of controlling a digital device, comprising the steps of:
receiving audio data of a first type and audio data of a second type different from the first type from an application via a pulse audio module;
informing an audio processing unit of reception of the first and the second type audio data via the pulse audio module;
controlling the pulse audio module to adjust outputs of the first and the second audio data based on a policy related to the first and the second type audio data via the audio processing unit; and
outputting at least one of the first type audio data and the second type audio data via the audio output unit based on a result of the adjustment.

14. The method of claim 13, wherein the policy relates to a port of the audio output unit to be used for outputting each of volume levels of the first and the second type audio data based on priority according to an audio data type and each of the first and the second type audio data.

15. The method of claim 13, wherein if the first type audio data corresponds to a TTS (text to speech) type among the first and the second type audio data, the outputting step comprises the step of outputting audio data corresponding to the first type audio data only among the first and the second type audio data via the audio output unit.
